(19) United States
(12) Patent Application Publication
(10) Pub. No.: US 2025/0053922 A1
(43) Pub. Date: Feb. 13, 2025

(54) AUTONOMOUS INVENTORY SYSTEM WITH INTELLIGENT CATALOGING METHOD

(71) Applicant: SAUDI ARABIAN OIL COMPANY, Dhahran (SA)

(72) Inventors: Abdullah Al-Yami, Dhahran (SA); Hassan R. Al-Dhafiri, Dhahran (SA); Majed O. Al-Rubaiyan, Dammam (SA); Khaled M. Al-Zain, Dhahran (SA)

(73) Assignee: SAUDI ARABIAN OIL COMPANY, Dhahran (SA)

(21) Appl. No.: 18/446,241

(22) Filed: Aug. 8, 2023

(51) Int. Cl. G06Q 10/0875; G06Q 10/067

(52) U.S. Cl. CPC G06Q 10/0875; G06Q 10/067

(57) ABSTRACT

A method of automated cataloging includes: receiving a request for cataloging an item as an inventory from the computer device; generating a catalog model, using information about one or more objects; applying the catalog model, using information about the item; and searching within a database for an entry belonging to a class in which the item is determined to be. The database stores information about inventories, and at least a part of the one or more objects is included in the inventories.

### BACKGROUND

Identification of inventory items and correct recounting of its quantity has been a basic and important aspect of everyday business. Large organizations which own and maintain equipment, tools and spare parts need to have an effective cataloging process to maximize the utility of these equipment and spare parts and to minimize the cost of maintaining such equipment and spare parts. Inventory items, such as parts or components used in manufacturing articles, can constantly change in its quantity and/or location by their nature. While operators need to trust inventory data and the reliability of data is essential, the creation and maintenance of inventory data has been a challenge due to the difficulty of identifying and tracking various items when a handler storing and/or moving an item is not familiar with its identifier, specification, etc. In the absence of an effective, intelligent, and autonomous inventory (or cataloging) process, organizations have to hire many employees to manually catalog equipment and spare parts. The manual cataloging process is ineffective because not only is it time-consuming but also is subject to records duplications and errors. Even if existing software is used to save inventory data, busy users may make mistakes when entering data into a file. Also, inventory data are often generated in isolation from other operational data and corporate records.

Automation of cataloging new inventory items (or identification) and documentation of existing inventory items, performed like a human expert but without using knowledge or experience of actual human handlers, is highly desirable. Additionally, the construction of inventory data based on all the pertinent information fuels accuracy and efficiency, by making data more accessible, transparent, and interoperable. Accordingly, there exists a need for a method and a system of creating a cataloged database of inventory that achieves aforementioned purposes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, one or more embodiments relate to a method of automated cataloging (or inventory). The method includes: receiving a request for cataloging an item in an inventory from a computer device; generating a catalog model, using information about one or more objects; applying the catalog model, using information about the item; and searching within a database for an entry belonging to a class in which the item is determined to be. The database stores information about inventories. At least a part of the one or more objects is included in the inventories.

In another aspect, one or more embodiments relate to a system of automated cataloging (or inventory). The system includes a hardware processor in data communication with a computer device and a database that: receives a request for cataloging an item as an inventory from the computer device; generates a catalog model, using information about one or more objects; applies the catalog model, using information about the item; and searches within a database for an entry belonging to a class in which the item is determined to be. The system further includes the database configured to store information about inventories. At least a part of the one or more objects is included in the inventories.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows a schematic view of structures and operations implementing an autonomous inventory (or cataloging) system in accordance with one or more embodiments.

FIG. 2A shows a schematic diagram of an autonomous inventory (or cataloging) system in accordance with one or more embodiments.

FIG. 2B shows a schematic diagram of a data linking process in accordance with one or more embodiments.

FIG. 3A shows a schematic diagram of a neural network for a catalog model in accordance with one or more embodiments.

FIG. 3B shows a schematic diagram of a recurrent neural network in accordance with one or more embodiments.

FIG. 3C shows a schematic diagram illustrating a neural network with an encoder and decoder in accordance with one or more embodiments.

FIG. 4A shows a block diagram showing the autonomous inventory system with a catalog model in accordance with one or more embodiments.

FIG. 4B shows a block diagram illustrating the autonomous inventory system with a catalog model in accordance with one or more embodiments.

FIG. 5 shows a block diagram illustrating the autonomous inventory system in accordance with one or more embodiments.

FIG. 6 shows a schematic diagram of the autonomous inventory system in accordance with one or more embodiments.

FIG. 7 shows a graph of one exemplary implementation of attention mechanism in the autonomous inventory system in accordance with one or more embodiments.

FIG. 8 shows a schematic diagram illustrating the autonomous inventory system with a catalog model in accordance with one or more embodiments.

FIGS. 9A to 9P show schematic views of screens of the autonomous inventory system in accordance with one or more embodiments.

FIGS. 10A to 10C show flow charts of a method of autonomous inventory system in accordance with one or more embodiments.

FIG. 11 shows a schematic diagram of the autonomous inventory system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments disclosed herein relate to an autonomous inventory system and a method of automated cataloging. Cataloging is the process of classifying categorizing, indexing, and recording equipment, products, articles, and spare parts, and restructuring data and conducting data entry thereof, for an organization. Organizations often employ many engineering specialists to catalog thousands of equipment, tools, and spare parts. The objective of cataloging is to facilitate for ordering spare parts in an efficient and cost-effective manner. Embodiments disclosed herein relate to an intelligent cataloging method in which a request for cataloging an item is received and a catalog model is generated for determining whether there is an entry in the class of the item in a database. In another aspect, embodiments disclosed herein relate to an autonomous inventory system and a method of automated cataloging that applies a catalog model generated based on a deep learning algorithm to determine the class of the item.

In this disclosure, the term “model” means “computer program,” “software,” “instructions to computing devices,” “neural network algorithm,” “deep learning algorithm,” “machine learning algorithm,” “software program architecture,” and the like, in a context-depending manner. The term “processor” includes “hardware processor,” “coprocessor,” “hardware processors located at a server.” and the like. The term “catalog model” refers to either a single model or multiple models. The term “cataloging” includes “classifying,” “identifying,” “differentiating,” “grouping,” “recording,” “restructuring data of,” “counting,” “conducting data entry of,” “numbering,” “assigning an identifier,” “naming,” “recognizing in an inventory system.” The term “one or more objects” includes a group of objects belonging to various classes and includes both objects in an inventory (inventories) of a business for which the cataloging system is implemented and objects not in the inventory of the business. At least a part of the one or more objects is included in the inventories. The term “database” refers to any repository or data structure capable of storing information.

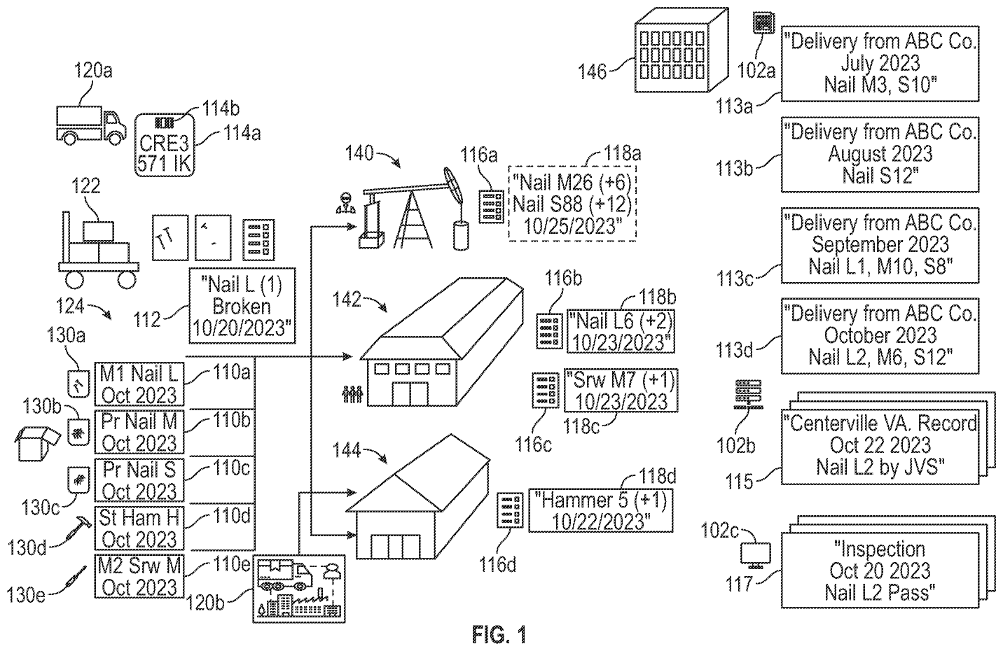

Referring to FIG. 1, FIG. 1 shows a schematic view of structures and operations implementing an autonomous inventory system in accordance with one or more embodiments.

As illustrated in FIG. 1, the autonomous inventory system 100 may be implemented in operations and structures having one or more business locations (e.g., headquarter 146). Likewise, one or more production sites (e.g., production wells) 140, one or more manufacturing sites 142, and one or more storage sites 144 may be included as part of the autonomous inventory system 100. The autonomous inventory system 100 may comprise databases generated from data about deliveries by delivery vehicles 120a, inspections at inspection or examination sites 122, grouping of products at distribution chains 124, transactions of the business, for example. The databases may include a corporate database, a catalog database, a multiplicity of recording units, and data obtained by information acquisition tools. Information of articles entering and exiting (including consumption) within the operations and structures shown in FIG. 1 is essential for business operations.

The autonomous inventory system 100 established according to one or more embodiments of the present invention enables entities to: evaluate and manage corporate assets, i.e., stocked articles that are used for manufacturing, transporting, and maintaining products; determine distribution of purchased and manufactured products in view of their consumption, destruction, or loss; improve the accuracy and efficiency of inventory; reduce costs associated with inventory; capture dynamic changes in logistics or storage; and check performances of employees and business affiliates by precisely and controlling inventory in a uniform and efficient manner, as described in detail in the following sections.

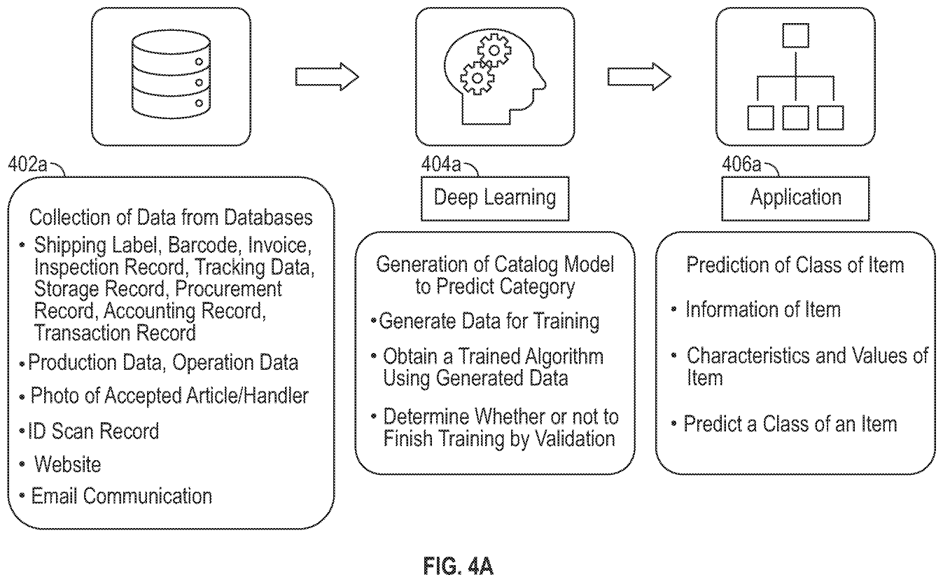

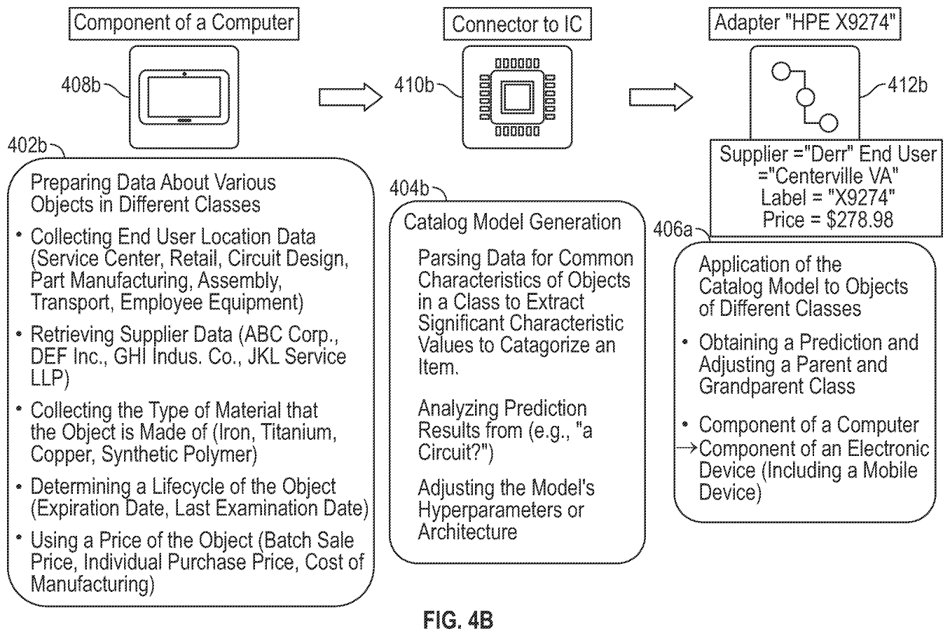

In some embodiments, the processor of the autonomous inventory system 100 may collect information about one or more objects, including collecting and using data about the one or more objects from corporate databases 214, catalog database (CD) 216, sensed data generated by sensors, internal and external electronic files, and websites. The processor of the system 100 may generate a set of inputs from collected information, as is explained more fully in relation to FIGS. 4A, 4B, 5, 6, and 7.

In some example implementations, the processor of the system 100 may collect data about one or more mechanic tools, including a nail, a hammer, and a screw, as shown in FIG. 1. For example, when a business obtains one or more mechanic tools, data about the one or more mechanic tools may be obtained from data on a label 114a and data on a barcode 114b included in a shipping container. Also, when the one or more mechanic tools are inspected, the processor of the system 100 may obtain data about the one or more mechanic tools (e.g., inspected nail data 112) from an inspection record 117, indicating that a large nail was returned to its supplier and removed from transportation to a storage site due to a product defect. Further, when the one or more mechanic tools are sorted for transportation, data about various types of tools (e.g., delivered tools 110a, 110b, 110c, 110d, 110e) among the one or more mechanic tools may be obtained from a sorting record, indicating that one large nail was transported to a manufacturing site M1 and several medium nails were transported to a production site, and so on. Subsequent to the transportation, the business may enter a receipt of the one or more mechanic tools into a record, but may omit making a data entry. Accordingly, when the one or more mechanic tools are received by a handler at the manufacturing site 142 and by a manager at the storage 144, the processor of the system 100 may obtain acceptance data 118b, 118c, 118d about various types of received tools from records of receipt or acceptance records 116b, 116c, 116d, but not necessarily obtain acceptance data 118a about nails accepted at the production site 140. Additionally, when the headquarter 146 (e.g., the accounting unit) receives an invoice from suppliers of the one or more tools, or when managers of the group using the one or more mechanic tools file reports into one or more corporate databases 214 or corporate records 102a, 102b, 102c, the processor of the system 100 may obtain data about the one or more mechanic tools (invoices 113a, 113b, 113c, 113d, storage records 115, inspection records 117). All of the foregoing data may constitute “information about the one or more objects” as used in the following paragraphs.

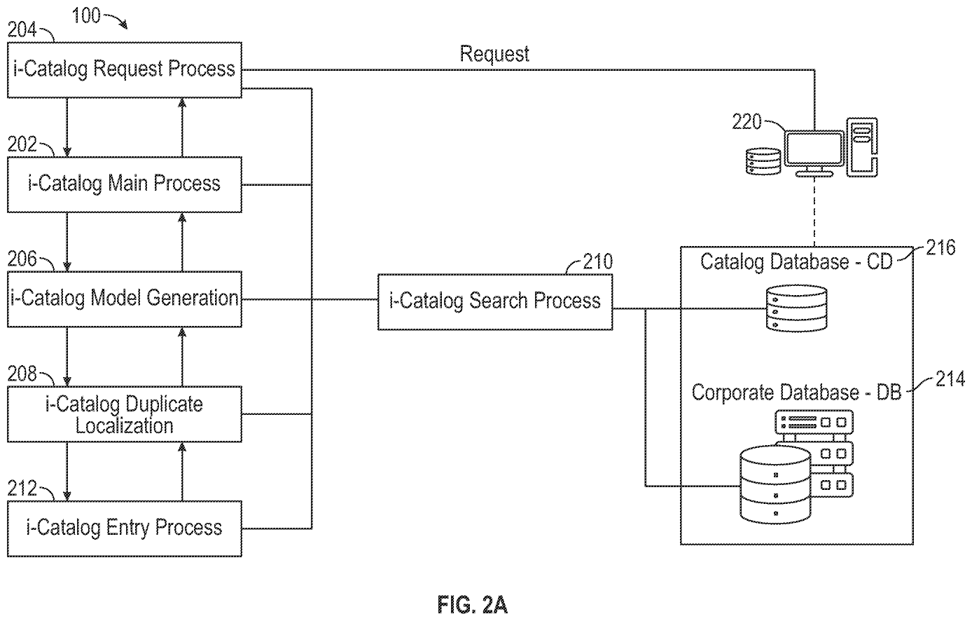

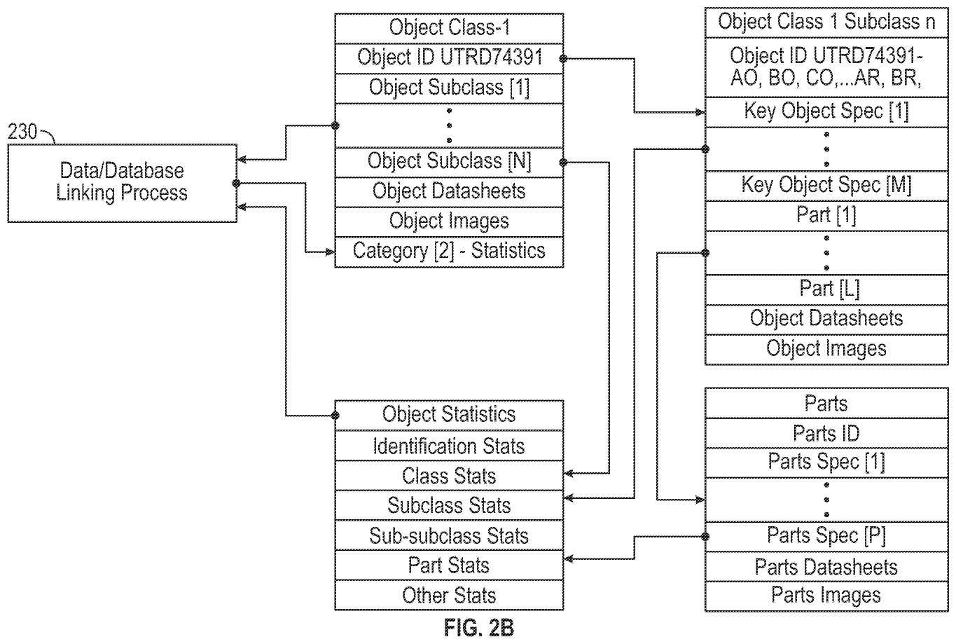

Turning to FIG. 2A, FIG. 2A shows a schematic diagram of the autonomous inventory system 100 in accordance with one or more embodiments.

More specifically, FIGS. 2A and 2B illustrate one embodiment of how autonomous inventory system 100 may be implemented. As illustrated in FIG. 2A, the system 100 receives a request for cataloging an item (in an inventory or from an external source) from a computer 220 or other computing device in data communication with the processor of the system 100. The processor of the system 100 may determine a class of the item and update relevant databases, including a catalog database (CD) 216 and a corporate database(s) (DB) 214 to account for the item in the inventory.

In one or more embodiments, the system 100 is comprised of one main process, a plurality of subprocesses, and a back-end that helps execute the catalog method (CM). For example, the back-end may be an Entity Relational Diagram (ERD). More specifically, the main process, i-Catalog Main Process (i-CMP) 202, including a processor performing Catalog Main Process 202, makes use of the subprocesses: i-Catalog Request Process (i-CRP) 204, i-Catalog Model Generation (i-CMG) 206, i-Catalog Duplicate Localization (i-CDL) 208, i-Catalog Search Process (i-CSP) 210, and i-Catalog Entry Process (i-CEP) 212 to validate the cataloging requests, conducts duplication analysis and search, and perform the cataloging data entries. The subprocesses validate a cataloging request, conduct class analysis and search, and enter cataloging data, as shown in FIG. 2A. Data/database Linking Process (“DLP,” inclusive of the processor performing Data/database Linking Process) 230, shown in FIG. 2B, is configured to implement the system 100 in communication with various databases, including the catalog database 216. The system 100, having these intelligent processes, eliminates manual entry of an inventory, cuts down work and expense of search, achieves de-duplication, and optimizes documentation of products and parts in the inventory in an autonomous and intelligent manner.

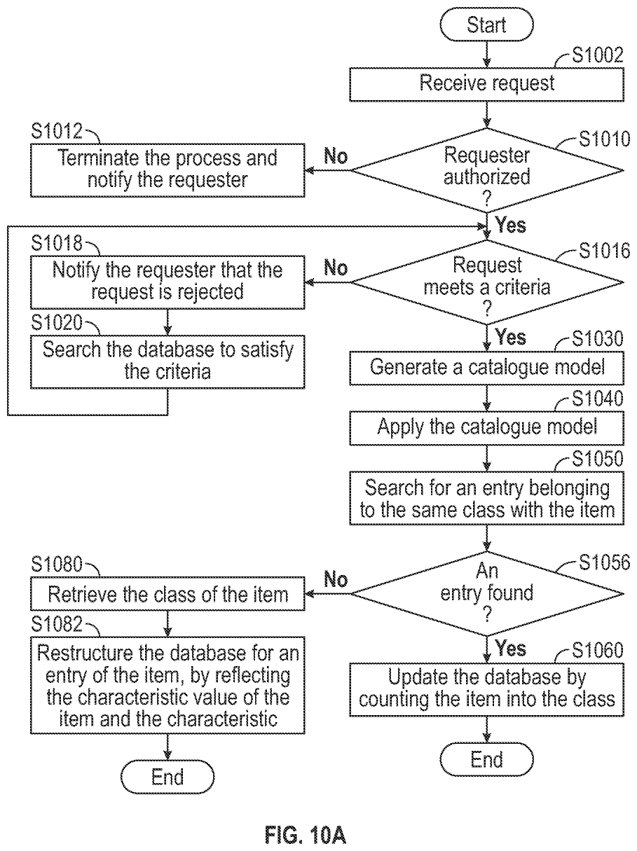

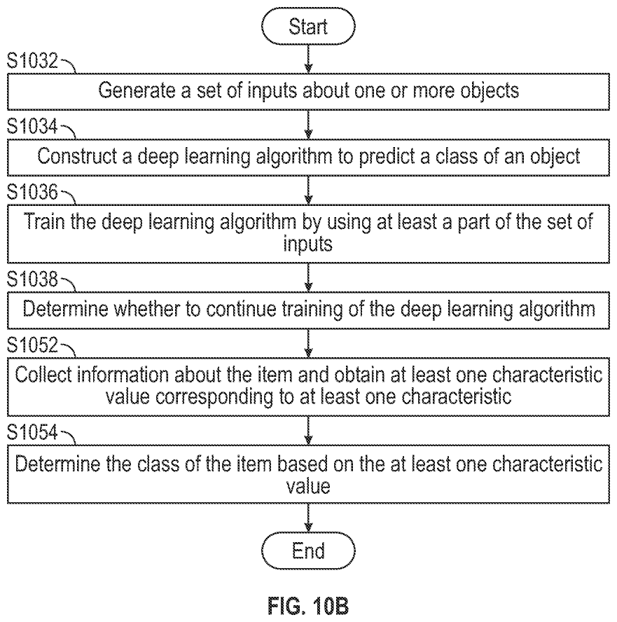

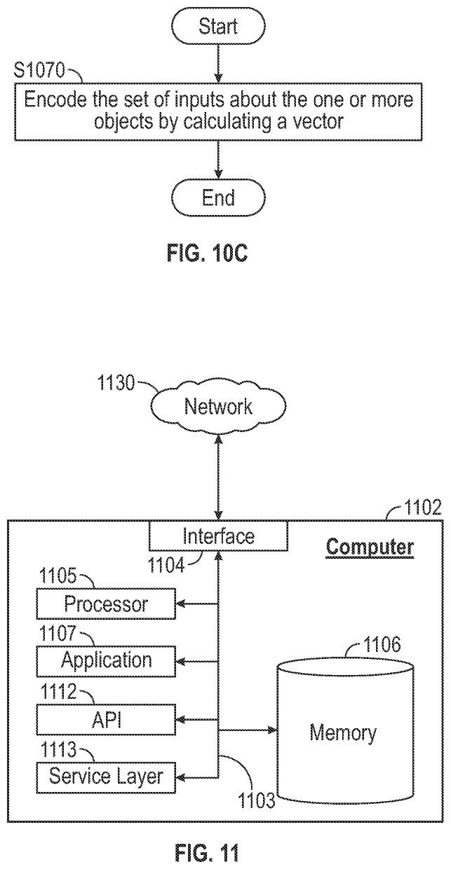

As shown in FIG. 2A, the system 100 operates in an environment in which i-CMP 202 communicates with the following sub-processors: i-CRP 204; i-CSP 210; i-CDL 208; i-CEP 212; and i-CMG 206. In one or more embodiments, i-CMP 202 commands i-CRP 204 to verify a request for cataloging an item received from a computer device 220. i-CRP 204 determines whether a requester for cataloging the item has authority to make the request. When the request is made by an authorized requester, i-CMP 202 instructs generation of a catalog model by i-CMG 206 (and jointly by i-CSP 210 if applicable). i-CDL 208 conducts a search of database(s) (including the corporate database 214, and the catalog database 216) for a duplicate of the item based on a structured search method. Once a duplicate item belonging to the class of the item is identified in the catalog database 216, i-CMP 202 terminates the cataloging process to prevent the cataloging of a duplicate record. If no other item is found, i-CMP 202 retrieves a relevant class of the item, and restructure item characteristic fields and values. i-CEP 208 receives an output created by the i-CMP 202 to generate a data entry regarding the item (and link the item to the other item, if applicable). DLP 230, shown in FIG. 2B, is designed to help the execution of the processor of the system 100. Methods and functions performed by the foregoing processes are described in FIGS. 10A to 10C.

The system 100 may include i-CMP 202 with an interface (an I/O unit) that receives the request for cataloging the item from a computer device 220 operated by a requester, according to one or more embodiments. For example, the request for cataloging triggers verification steps at i-CRP 204. i-CMP 202 conveys the request for cataloging to i-CRP 204 and instructs i-CRP 204 to determine the requester's authority. i-CRP 204 may check the requester's identification against a list of authorized users in the corporate database 214. When i-CRP 204 determines that the requester does not have the authority to make the request for cataloging, it triggers a transmission of the determination from i-CRP 204 to i-CMP 202. And i-CMP 202 terminates processing of the request.

In some embodiments, when i-CRP 204 determines that the requester has the authority to make the request for cataloging, i-CRP 204 proceeds to check the satisfaction of criteria for cataloging requests and conducts verification of the request to ensure that the request meets criteria as set by i-CMP 202. In some examples, the request is required to include the requestor fields, the criteria fields, and the documents fields.

As to the requestor fields, the criteria for a request for cataloging may include: requester/end user data; facility type, for instance, drilling sites; and facility layout. As to the criteria fields, the following may be required: cataloging policies; equipment type and counts; and mandatory item characteristic fields. The documents fields may encompass: engineering standards; equipment drawings; and supplier's data.

If the criteria are not met, a notification is sent to the requester. If the criteria are met, i-CRP 204 verifies whether required documentations that should come with the request are included. If an essential document is missing, then a notification is sent to the requester and the process ends. i-CRP 204 rejects the request missing essential information. In one or more embodiments, when i-CRP 204 cannot verify that the request submitted required documentation/data, a notification is sent to the requester. i-CRP 204 may search the database to satisfy the criteria, including the corporate database 214.

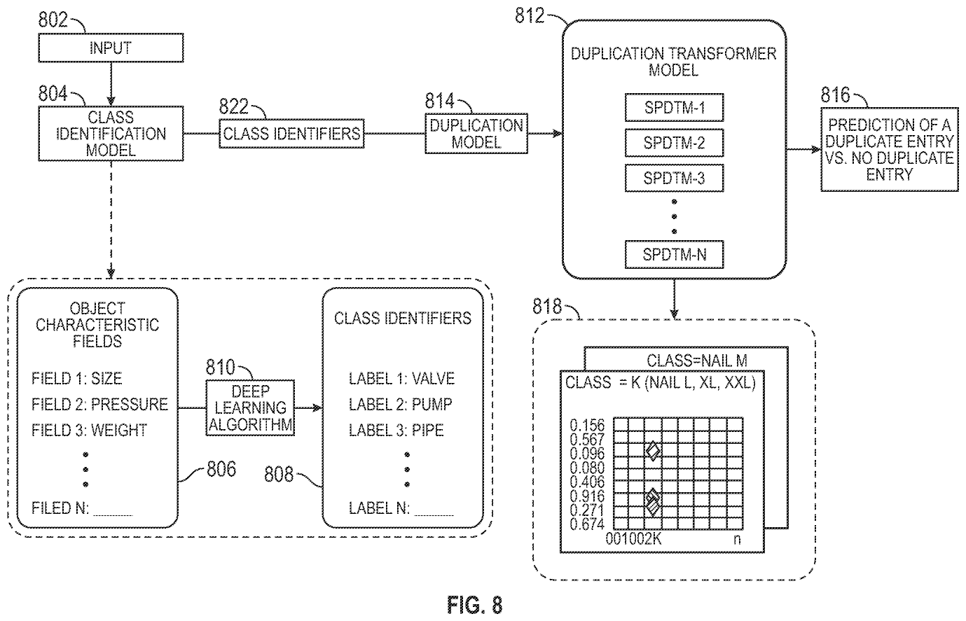

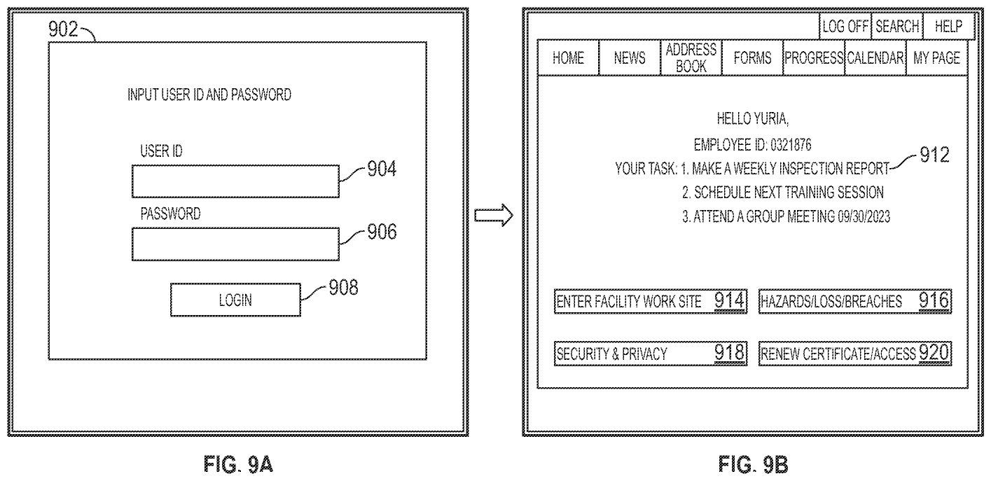

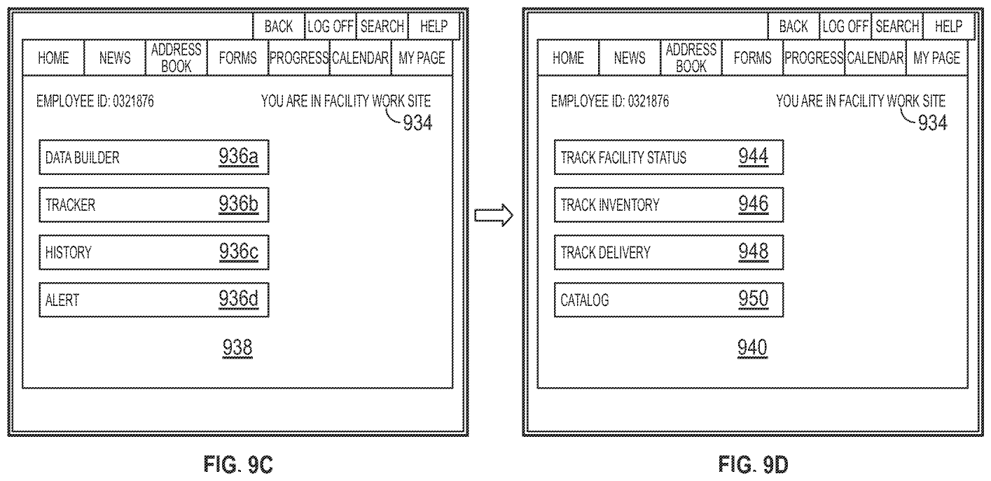

If all documentations are included, the i-CMP 202 may carry out the rest of processes. Once the request is verified, the processor of the system 100 initiates generation of a catalog model that i-CMP 202 uses for class determination analysis of the item for which the request is being made. The processor of the system 100 may generate the catalog model by an instruction of i-CMP 202 to i-CMG 206. As depicted in FIG. 8, the catalog model may include Class Identification Model (CIM) 804, Duplication Model (DM) 814, and Duplication Transformer Model (DTM) 812 in some embodiments. Once the catalog model is generated by i-CMG 206, i-CMP 202 may apply the catalog model to determine the class of the item.

i-CMG 206, in generating the catalog model, may collect information about the one or more objects and generate a set of inputs about the one or more objects to train a deep learning algorithm. The set of inputs may include, for each of the one or more objects, a class of the one or more objects and a characteristic value (e.g., “large” “small” “number 003974” “broken”) of the one or more objects corresponding to a characteristic (e.g., size, model, weight, use, maker, etc.) according to one or more embodiments.

In one or more embodiments, i-CMG 206 may construct a deep learning algorithm to predict a class of an object. Additional details of the catalog model generation are explained later in relation to FIG. 8. i-CMG 206 may train the deep learning algorithm and obtain the catalog model, by using at least a part of the set of inputs. i-CMG 206 may determine whether to continue training of the deep learning algorithm by examining outputs of the catalog model.

Once the catalog model is created, i-CMP 202 may produce a list of scenarios about class-defining characteristics of the one or more objects that belong to various classes, using parameters VarThresholdCR, and Variable Counter (VarCounterCR) in one or more embodiments. Each scenario contains a certain class-defining characteristic(s) with respective value(s), which may be used in identifying a class of the item. The generated list of scenarios may be stored in the corporate database 214 and/or the catalog database 216. Additional details of the catalog model application are explained later in relation to FIG. 8.

In one or more embodiments, i-CMP 202 collects information about the item, obtains at least one characteristic value corresponding to the at least one characteristic, and determines the class of the item based on the at least one characteristic value. In some embodiments, the VarCounterCR may be computed for each scenario in sequence, until all the characteristics within the scenario are found, or all predefined scenarios are executed. If one scenario yields results, i-CMP 202 retrieves the class and a template. The identification of the class of the item enables i-CMP 202 to set at least one characteristic to be included for search by i-CSP 210. The selection of the at least one characteristic may be based on an output of application of the catalog model to the information about the item. i-CMP 202 may set Variable Threshold (VarThresholdCR) and Variable Counter (VarCounterCR) to a positive integer and zero, respectively, which reflects the characteristic value of the item with regards to the characteristic.

The application of the catalog model to all the accessible data about the item may not realize i-CMP's 202 class determination. In such circumstance, i-CMP 202 sends a notification to the requester that there is no identifiable class, according to one or more embodiments of the present invention.

In other embodiments, upon determining the class of the item, the system 100 may determine whether there is another entry (a spare of the item) in the class in which the item is determined to be in, by prompting i-CDL 208 to conduct search within accessible databases, e.g., the catalog database 216 and the corporate database 214, to see whether there is an entry in the class which the item is determined to be in. The class information as well as other pertinent characteristics may be provided into the trained model to determine whether a duplicate of the item exists in the catalog database. i-CDL 208 may, in some examples, execute inputs simultaneously in order to identify specifications of a duplicate (a spare) of the item. Once specifications of a duplicate are identified, i-CSP 210 will look for an identifier 822 in the catalog database 216 that matches specifications of a duplicate. Then, a link may be created with the item to the identifier 822.

In some embodiments, when i-CDL 208 finds another entry belonging to the class in which the item is determined to be, i-CMP 202 may update the catalog database 216 by counting the item into the class. i-CMP 202 may communicate directly with the catalog database 216, as well as the corporate databases 214 (including corporate records 102a, 102b, 102c in FIG. 1), to collect required data.

In some examples, i-CDL 208 may find no entry (duplicate, spare) in the class of the item in all accessible databases including the catalog database 216 and the corporate database 214. If i-CDL 208 conducts search and finds no entry belonging to the class in which the item is determined to be, i-CMP 202 retrieves the class of the item. The item's characteristics, and characteristic values are shared with i-CMP 202, and then transmitted to i-CEP 212.

In one or more embodiments, i-CEP 212 may receive an output of i-CMP 202 to generate a data entry of the item. i-CEP 212 may populate and restructure the characteristics and their respective values of objects in various classes with data obtained from the i-CMP 202, thus creating logical relationship between the request for the item and the characteristic values saved in the catalog database 216. Two variables; Variable Threshold (VarThresholdCEP), which is the threshold for a number of matched characteristics as specified in Characteristic Fields (explained later) of a particular class and Variable Counter (VarCounterCEP), which is the counting of matched characteristics specified in the Characteristic Fields, are initiated to a certain threshold; positive integer and zero, respectively. VarThresholdCEP stores the number of the Characteristic Fields corresponding to the class obtained from the catalog database 216 (CharFieldCD), which are pertinent characteristics of the particular class as specified in Characteristic Fields in the catalog database 216. For example, VarCounterCEP counts each CharFieldCD that has been matched with corresponding characteristics of the item to be cataloged. The VarCounterCEP is incremented, for each characteristic of the item matched against each CharFieldCD, until the maximum VarThresholdCEP is reached. Each characteristic value of the item may be transferred to the corresponding CharValCD, which is the characteristic value of the pertinent characteristics in the catalog database 216. The processor of the system 100 may generate an identifier (a stock number) 822 and link to the item being cataloged.

As shown in FIG. 2A, i-CSP 210 conducts a comprehensive search in all accessible databases including the catalog database 216 and the corporate database 214. i-CSP 210 receives a search request with specific search parameters from other processors (i-CMP 202, i-CDL 208, i-CMG 206, etc.) according to one or more embodiments. For example, i-CSP 210 utilizes a search criteria of a deep learning algorithm within the database. i-CSP 210 determines whether each parameter yields results. If no results are found, i-CSP 210 notifies the relevant processors to adjust the algorithm and modify the search criteria/parameters.

Turning to FIG. 2B, DLP 230 is designed to help the execution of other processors (i-CMP 202, i-CDL 208, i-CMG 206, etc.) according to one or more embodiments. The catalog database 216 contains data about objects of various classes (subclasses, etc.). In some implementations, DLP 230 may execute an instruction for modifying hierarchies. For instance, one class (a nail) may have several subclasses (large, medium, and small). The main class and its subclasses are linked to their member objects, as well as characteristics (facility locations, use types, etc.). A table may be created to indicate relationships between all classes, subclasses, and member objects. For example, if a pump is classified as class UTRD74391, then a motor driving the pump may be classified as subclass UTRD74391-AR, a gearbox that couples the pump to the motor may be classified as UTRD74391-GR, and so on. UTRD74391-AR and UTRD74391-GR are considered as parts for UTRD74391. Parts for the pump, the motor, and the gearbox are classified as UTRD74391-05, UTRD74391-AR-62, UTRD74391-GR-26, respectively.

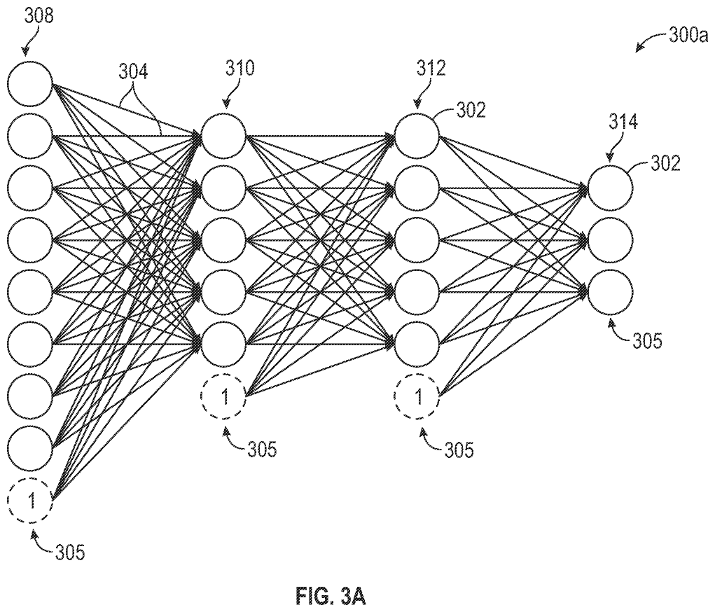

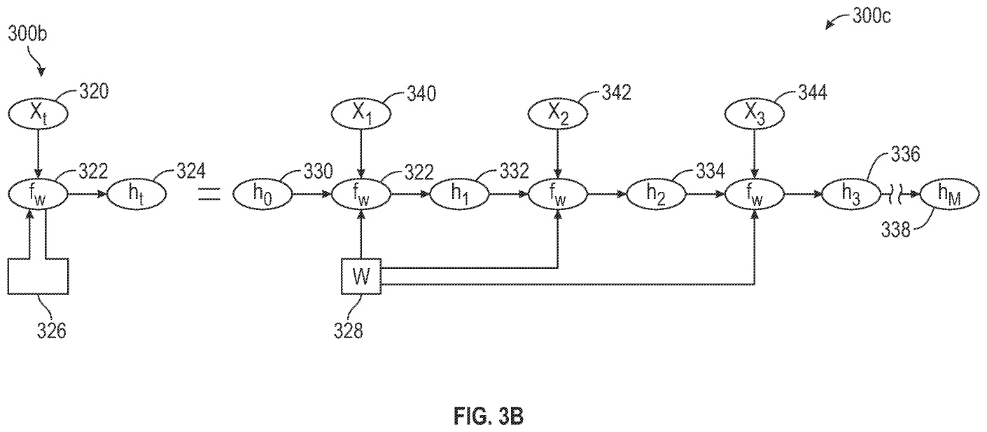

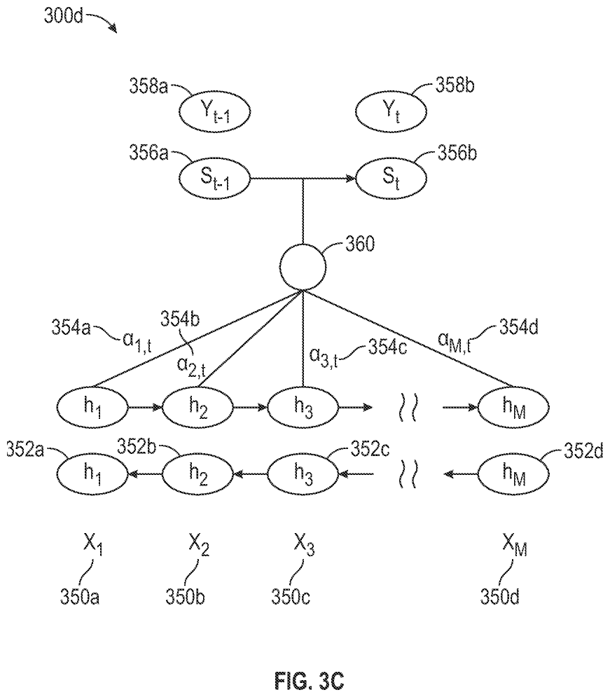

Turning to FIG. 3A, the following paragraphs explain how the processor of the system 100 may determine a class (a class, including a subclass, such as an order, a family, a genus, a species) of the one or more objects, and ultimately the class of the item considering various characteristics unique to each class of objects.

Machine learning (ML), broadly defined, is the extraction of patterns and insights from data. The phrases “artificial intelligence,” “machine learning,” “deep learning,” and “pattern recognition” are often convoluted, interchanged, and used synonymously. This ambiguity arises because the field of “extracting patterns and insights from data” was developed simultaneously and disjointedly among a number of classical arts like mathematics, statistics, and computer science. For consistency, the term machine learning, or machine learned, is adopted herein. However, one skilled in the art will recognize that the concepts and methods detailed hereafter are not limited by this choice of nomenclature.

In some embodiments, the ML model may be either a feedforward neural network (FNN), such as a traditional one directional neural network, or a recurrent neural network (RNN). Thus, a cursory introduction to NN and RNN is provided herein. However, note that many variations of an NN and an RNN exist. Therefore, one of ordinary skill in the art will recognize that any variation of an NN or an RNN (or any other ML model) may be employed without departing from the scope of this disclosure. Further, it is emphasized that the following discussions of an NN and a CNN are basic summaries and should not be considered limiting.

The ML model may be constructed by a recurrent neural convolutional network, such as PixelCNN. An RCNN is a specialized neural network (NN) and, from there, a specialized convolutional neural network (CNN).

A diagram of an NN is shown in FIG. 3A. At a high level, an NN 300a may be graphically depicted as being composed of nodes 302 and edges 304. The nodes 302 may be grouped to form layers. FIG. 3A displays four layers 308, 310, 312, 314 of nodes 302 where the nodes 302 are grouped into columns. However, each group need not be as shown in FIG. 3A. The edges 304 connect the nodes 302 to other nodes 302. Edges 304 may connect, or not connect, to any node(s) 302 regardless of which layer the node(s) 302 is in. That is, the nodes 302 may be sparsely and residually connected. For example, in some recurrent neural networks (RNN), nodes 302 in the output layer may be connected by edges 304 to nodes 302 in the input layer 308.

An NN 300a has at least two layers, where the first layer 308 is the “input layer” and the last layer 314 is the “output layer.” Any intermediate layer 310, 312 is usually described as a “hidden layer.” An NN 300a may have zero or more hidden layers 310, 312. An NN 300a with at least one hidden layer 310, 312 may be described as a “deep” neural network or “deep learning method.” In general, an NN 300a may have more than one node 302 in the output layer 314. In these cases, the neural network 300a may be referred to as a “multi-target” or “multi-output” network.

Nodes 302 and edges 304 carry associations. Namely, every edge 304 is associated with a numerical value. The edge numerical values, or even the edges 304 themselves, are often referred to as “weights” or “parameters.” While training an NN 300a, a process that is described below, numerical values are assigned to each edge 304. Additionally, every node 302 is associated with a numerical value and may also be associated with an activation function. Activation functions are not limited to any functional class, but traditionally follow the form:

$$A = f ( {\sum }_{i ∈ ( incoming )} [ {( node value )}_{i} {( edge value )}_{i} ] ) , \qquad Equation ( 1 )$$

where i is an index that spans the set of “incoming” nodes 302 and edges 304 and f is a user-defined function. Incoming nodes 302 are those that, when viewed as a graph (as in FIG. 3A), have directed arrows that point to the node 302 where the numerical value is being computed. Some functions ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node 302 in an NN 300a may have a different associated activation function. Often, as a shorthand, activation functions are described by the function ƒ by which it is composed. That is, an activation function composed of a linear function ƒ may simply be referred to as a linear activation function without undue ambiguity.

When the NN 300a receives an input, the input is propagated through the network according to the activation functions and incoming node values and edge values to compute a value for each node 302. That is, the numerical value for each node 302 may change for each received input while the edge values remain unchanged. Occasionally, nodes 302 are assigned fixed numerical values, such as the value of 1. These fixed nodes are not affected by the input or altered according to edge values and activation functions. Fixed nodes are often referred to as “biases” or “bias nodes” as displayed in FIG. 3A with a dashed circle.

In some implementations, the NN 300a may contain specialized layers, such as a normalization layer, pooling layer, or additional connection procedures, like concatenation. One skilled in the art will appreciate that these alterations do not exceed the scope of this disclosure.

The number of layers in an NN 300a, choice of activation functions, inclusion of batch normalization layers, and regularization strength, among others, may be described as “hyperparameters” that are associated to the ML model. It is noted that in the context of ML, the regularization of a ML model refers to a penalty applied to the loss function of the ML model. The selection of hyperparameters associated to a ML model is commonly referred to as selecting the ML model “architecture.”

Once a ML model, such as an NN 300a, and associated hyperparameters have been selected, the ML model may be trained. To do so, M training pairs may be provided to the NN 300a, where M is an integer greater than or equal to one. The variable m maintains a count of the M training pairs. As such, m is an integer between 1 and M inclusive of 1 and M where m is the current training pair of interest. For example, if M=2, the two training pairs include a first training pair and a second training pair each of which may be generically denoted an mth training pair. In general, each of the M training pairs includes an input and an associated target output. Each associated target output represents the “ground truth,” or the otherwise desired output upon processing the input. During training, the NN 300a processes at least one input from an mth training pair to produce at least one output. Each NN output is then compared to the associated target output from the mth training pair.

Returning to the NN 300a in FIG. 3A, the NN 300a may be trained by first assigning initial values to the edges 304. These values may be assigned randomly, according to a prescribed distribution, manually, or by some other assignment mechanism. Once edge values have been initialized, the NN 300a may act as a function such that it may receive an input from an mth training pair and produce an output. At least one input is propagated through the neural network 300a to produce an output. The M training pairs is discussed in more detail below.

The comparison of the NN output to the associated target output from the mth training pair is typically performed by a “loss function.” Other names for this comparison function include an “error function,” “misfit function,” and “cost function.” Many types of loss functions are available, such as the log-likelihood function. However, the general characteristic of a loss function is that the loss function provides a numerical evaluation of the similarity between the NN output and the associated target output from the mth training pair. The loss function may also be constructed to impose additional constraints on the values assumed by the edges 304. For example, a penalty term, which may be physics-based, or a regularization term may be added. Generally, the goal of a training procedure is to alter the edge values to promote similarity between the NN output and associated target output for most, if not all, of the M training pairs. Thus, the loss function is used to guide changes made to the edge values. This process is typically referred to as “backpropagation.”

While a full review of the backpropagation process exceeds the scope of this disclosure, a brief summary is provided. Backpropagation consists of computing the gradient of the loss function over the edge values. The gradient indicates the direction of change in the edge values that results in the greatest change to the loss function. Because the gradient is local to the current edge values, the edge values are typically updated by a “step” in the direction indicated by the gradient. The step size is often referred to as the “learning rate” and need not remain fixed during the training process. Additionally, the step size and direction may be informed by previous edge values or previously computed gradients. Such methods for determining the step direction are usually referred to as “momentum” based methods.

Once the edge values of the NN 300a have been updated through the backpropagation process, the NN 300a will likely produce different outputs than it did previously. Thus, the procedure of propagating at least one input from an mth training pair through the NN 300a, comparing the NN output with the associated target output from the mth training pair with a loss function, computing the gradient of the loss function with respect to the edge values, and updating the edge values with a step guided by the gradient is repeated until a termination criterion is reached. Common termination criteria include, but are not limited to, reaching a fixed number of edge updates (otherwise known as an iteration counter), reaching a diminishing learning rate, noting no appreciable change in the loss function between iterations, or reaching a specified performance metric as evaluated on the m training pairs or separate hold-out training pairs (often denoted “validation data”). Once the termination criterion is satisfied, the edge values are no longer altered and the neural network 300a is said to be “trained.”

Turning to FIG. 3B, FIG. 3B shows a schematic diagram illustrating a catalog model constructed with an RNN 300b, 300c. As shown in FIG. 3B, to generate a prediction model on an RNN, the network 300b, 300c is initialized with a vector as a hidden state h₀ 330. The first hidden state h₁ 332 arrives with a receipt of the first input x₁ 340 at the RNN 300b, 300c. When the second input x₂ 342 is received, a new hidden state h₂ 334 appears and the network 300b, 300c again receives h₂ 334 with the second input x₂ 342. The process repeats until the final output h_{M} 338 of the network 300b, 300c is obtained.

As such, RNNs 300b, 300c, are characterized by their recurrent use of previous inputs, as represented in the node 332 having a self-pointing loop (or a feedback loop) 326. Hidden states 324 in RNNs 300b, 300c function similar to nodes 302 of hidden layers 310, 312 in NNs. In contrast to feedforward NN (FNN), in RNNs 300b, 300c, layers have three parameters: an input x 320, 340, 342, 344, bias, and a weight w 328, and RNNs share weights 328 across various nodes. That is, identical weights may be placed for every timestep of the iteration. In one simplified example (a single parameter w 328, no bias), a current hidden state hₜ 324, 330, 332, 334, 336 at unrolling step is described by the following relation, where xₜ 320, 340, 342, 344, is an input at each timestep, and w 328 is a parameter matric weight:

$${h}_{t} = w \cdot ( {x}_{t} + {h}_{t - 1} ) \qquad ( A )$$

In RNN 300b, 300c architectures, an input at a timestep “t” xₜ 320, 340, 342, 344, and a hidden state at a timestep “t−1” hₜ₋₁ 330, 332, 334, 336 is passed through an activation layer to obtain a state at a timestep “t” hₜ 324, 332, 334, 336, 338.

In a case in which a final prediction (a single output) is made in view of a multiplicity of consecutive inputs, for example, a prediction of someone's emotion from a sequence of words or paragraphs of words, the output can be a regression output with continuous values which represent the likelihood of having a positive sentiment. These types of RNNs are often called many-to-one. Using the M training pairs and as previously described, the model is chosen based on the final hidden state h_{M} of the network, which unites the entire consecutive inputs.

RNN models are especially well suited to predict a status of a target (object, a sentence, a speech, a chemical structure, etc.) from sequential or interrelated data. Data are described more fully when data connections are analyzed in light of historical (sequential) information. RNNs' ability to maintain previous inputs becomes beneficial because time-series data are best interpreted by their sequential implications. Consequently, an RNN is a choice of an NN for processing sequential data such as voice recognition, translation of a sentence from one language to another, prediction of volcanic activities, etc.

While the RNN can process certain contextual data, RNNs generally cannot achieve a satisfactory result or make a correct prediction when inputs have contexts of significant lengths. RNNs may fail to give sufficient weight to information inputted much earlier, a number of steps before.

In one or more embodiments, the system 100 may construct the catalog model that benefits from long term memory, by making adjustments to the architecture of NN (or RNN). Long Short Term Memory (LSTM) and Gated Recurrent Units (GRU) are developed by modifying RNNs to implement the capability to learn long sequences. In LSTM, the activation layer receives an input combined from three different sources: an input at a present timestep; short term memory from a previous hidden state stored in a cell, and long term memory from a much earlier hidden state stored in a cell. In combining long term memory with short term memory, the network may be constructed with various gates to be placed, selecting which information to keep or discard before passing on. An output from the network becomes more accurate with careful choice of gates, such as input gates, forget gates, and output gates.

Encoding/decoding of data is frequently included in deep learning algorithms. A network can take an input sentence in the form of a sequence of vectors, and converts it into a vector via encoding, and obtain another sequence via decoding. An encoder/decoder may be implemented to determine an emotion or a present status of a person (a target) from a string of various segments representing expressions. An encoder RNN receives an input and outputs a context vector, by calculating the final hidden state. The context vector is inputted into a decoder RNN and results in a different output sequence. For example, the decoder outputs a sentence (“Thank you”) in response to the following conversations: “Do you know who got the prize?” “No, really?” “Yes, it's you.” “Oh . . . ” “Congratulations!”

According to one or more embodiments of the present disclosure, dynamic weighting may be incorporated into NNs such that every input from a source and each output before the present timestep may be taken into account to calculate an output. The attention mechanism is representatively described by the aggregation of products of each dynamic (alignment) weight for various parts in a sequence (keys) for a specific output (query). In the previous example of the output “Thank you,” when the encoder receives a sequence of several words, the weights of the parts (key) “No, really?” and “Oh . . . ” are considered relatively low, while the weight of the part “Congratulations!” is highest in relation to the query “Thank you.”

Turning to FIG. 3C. FIG. 3C shows a schematic diagram showing an example encoder and decoder of a neural network 300d. The network 300d may be formed with an encoder RNN (bidirectional) and a decoder RNN, in accordance with one or more embodiments of the present disclosure.

In implementations incorporating the attention mechanism, the network computes dynamic weights (scores) 354a, 354b, 354c, 354d of individual keys from serial inputs 350. The weights 354a, 354b, 354c, 354d represent a relative importance of each entry in a sequence for an output (query). A context vector cₜ 360 is calculated by obtaining a sum of a product of dynamically weighted a_{t,n} 354a, 354b, 354c, 354d and encoder hidden state vector hₙ 352a, 352b, 352c, 352d.

$${c}_{t} = {\sum }_{n = 1}^{N} ( {a}_{t , n} {h}_{n} ) \qquad ( B )$$

The output from the encoder cₜ 360 is obtained and inputted into the decoder. The decoder RNN receives the output cₜ 360 and the input from a previous state Sₜ₋₁ 356a and obtains a current state St 356b. The network 300d obtains an output yₜ 358b from St 356b.

In determining a class by generating a catalog model, the deep learning algorithm may incorporate Soft-max as a final activation layer of the decoder. In such examples, the network receives an output from a previous layer (Sₜ) and determines an output (a class of an object) yₜ. Non-normalized outputs are mapped to a probability distribution of classes. For example, the probability of an object belonging to a particular class is measured by a decimal, and the probabilities of all classes amount to 1.0. Soft-max is frequently utilized in the last layer of NN that functions as a classifier.

Accordingly, the processor of the system 100 may construct the deep learning algorithm from multiple stacked encoder layers according to one or more embodiments. Each encoder may consist of a self-attention sublayer and a feed-forward neural network sublayer. The self-attention sublayer captures the contextualized representations by attending to the entire sequence, while the feed-forward sublayer applies non-linear transformations to enhance the representations further.

Similar to context vectors explained above, transformers have been developed as the mechanism of attention has been introduced to handle contextual inputs. In those designs, different components are linked to each other (the keys and values). When transformers generate attention vectors, signals at each state are directly and dynamically weighted, and accordingly, the attention vectors may eliminate the need to use RNNs for the propagation and combination of sequential signals to a final hidden state. Incorporating transformers allows deep learning models to work with more parameters.

In one or more embodiments, for incorporating a transformer, or encoding or decoding of inputs, the deep learning algorithm may tokenize data about an object. Tokenization converts a string of data about an object into token indexes. Tokenization of a contextual data will render data readable by a transformer.

In addition to the methodologies described above, a person of ordinary skill in the art may advance the accuracy and reliability of the catalog model by, incorporating multiple LSTMs or GPUs. In some embodiments, the catalog model may be constructed on distributed training techniques when there are sufficient resources. The architecture may be adjusted in relation to a type, a size, and interrelatedness of input data. One or more embodiments may implement a network with reduced weight decays, using batch normalization or hyperparameter tuning.

Turning to FIG. 4A, FIG. 4A shows a block diagram showing the autonomous inventory system 100 with a catalog model in accordance with one or more embodiments. The first column of FIG. 4A lists the types of data that are collected from databases by the processor of the system 100 (e.g., i-CMG 206). The collected information is processed, and characteristics and corresponding characteristic values of the one or more objects may be obtained.

As explained above, in certain implementations, characteristics of the one or more objects may be obtained from information in a variety of sources, including the corporate database 214 and corporate records. For example, the processor of the system 100 may collect information about mechanical tools (nails 130a, 130b, 130c, hammers 130d, and screws 130e) from various sources. The processor of the system 100 may access the catalog database 216. Additionally, data assembled by the processor of the system 100, e.g., DLP 230, located in a memory of the system 100 in some examples, may also be retrieved.

Information may be collected from labels 114a and barcodes 114b created for shipping packages of the mechanic tools (nails 130a, 130b, 130c, hammers 130d, and screws 130e) that are received at the delivery site from delivery vehicles 120a. The data may be found in its original format or may be converted into electronic files and transferred to be saved in the corporate databases 214. Also, information may be collected from invoices 113a, 113b, 113c. 113d made by different suppliers of the one or more objects. Inspection data 112 of the one or more objects may be electronically transmitted from an inspection site to the processor of the system 100. The processor of the system 100 may also retrieve inspection data about the one or more objects from the inspection records 117 or the corporate database 214, which may include a condition, quantity, inspection result/date of each object. In some other instances, data from acceptance records 116a, 116b, 116c, 116d and/or storage records 115 of the one or more objects may be collected for analysis and distinguishing characteristics of each class of the one or more objects may be found. The processor of the system 100 may also access procurement records (including invoices 113a, 113b, 113c, 113d), accounting records, and transaction records that are held at the corporate headquator 146, e.g., the accounting or legal department. Production data and various operation data (history of repairment, loss, destruction, etc.) may be also obtained from the corporate databases 214 in order to uncover the characteristics of the one or more objects. These types of data in corporate records and the corporate database 214 may also contain identities of associated workers involved in activities, indicating certain groups of classes to which the one or more objects belong. In certain embodiments, the processor of the system 100 may access electronic data of photos of accepted objects captured when the one or more objects are delivered to the business and identify the objects by object recognition computer program. Other sources of information may include websites, internet postings, and/or email communications.

In some implementations, the system 100 may collect information about the one or more objects, by receiving information from an automated object recognition process. The processor of the system 100 (e.g., i-CMG 206) may collect information about the one or more objects and identify characteristics of the one or more objects that robots or autonomous systems have gathered. For example, Light Detection and Ranging Simultaneous Localization and Mapping (Lidar SLAM) may provide data about sensed objects and their surroundings to the processor of the system 100. Lidar sensors emit laser pulses and measure the gap time for the pulses' bouncing back after hitting objects. Lidar SLAMs may analyze the returned laser signals to create a set of parameters of spatial positions occupied by the objects in an environment.

In other implementations, solid-state Lidar sensors are suited to collect information about stationed objects without requiring a significant amount of power. Electronic beam steering methods, including optical phased arrays or microelectromechanical systems (MEMS) mirrors are used to scan a broad field of view. In addition to the positional information of the objects, sensors may collect information indicative of the item's physical landmarks, i.e., characteristics. Robots equipped with sensors may circumambulate rooms in a manufacturing facility to sense equipment and machinery. In these implementations, the robot can obtain data about surrounding objects to recognize each equipment and machinery in the facility. Sensed data may be referenced with corresponding data from other databases.

Still at FIG. 4A, the second column explains the generation of the catalog model by the processor of the system 100 (e.g., i-CMG 206, i-CSP 210).

Upon collecting relevant data from various sources as briefly described above, the processor of the system 100 may generate a set of inputs about the one or more objects. In one or more embodiments, the set of inputs about the one or more objects contain a characteristic value of the one or more objects corresponding to a characteristic. For example, the processor of the system 100 may collect information about mechanic tools (nails, hammers, and screws) from various sources.

In some embodiments, the processor of the system 100 trains the deep learning algorithm to optimize. Accordingly, the processor of the system 100 divides the collected data into a few sets and train the catalog model with one set of the collected data in which each data point is labeled as either existing or non-existing in the system. During training, the parameters of the network are optimized using techniques such as backpropagation and gradient descent to minimize a suitable loss function.

As example implementations, the processor of the system 100, e.g., i-CMG 206 may generate the catalog model, including CIM 804, DM 814, and DTM 812 (identifying and utilizing a relevant class of the one or more objects). For instance, the processor of the system 100 may construct a deep learning algorithm.

As described in relation to FIGS. 3A to 3C, the processor of the system 100 may establish the catalog model, using an NN as network architecture. More specifically, the process of the system 100 may initialize an RNN, such as LSTM and GRU, such that the catalog model may utilize contextualized representations of objects in certain classes to identify the correlation between data in the set of inputs. Alternatively, in some embodiments, the processor of the system 100 may construct the catalog model by incorporating a transformer. Additionally, the processor of the system 100 may conduct encoding of the set of inputs about the one or more objects by calculating a context vector and decoding an output from the encoding according to one or more embodiments. An encoder RNN and a decoder RNN are incorporated into the deep learning algorithm in order to analyze sequential elements in the set of inputs.

In other embodiments, the processor of the system 100 may construct the catalog model, e.g., CIM 804, based on multi-class Random Forest Classifier.

The processor of the system 100 may train the deep learning algorithm by using at least a part of the set of inputs. In training the deep learning algorithm, the processor may evaluate the accuracy of prediction of a class by the catalog model at certain intervals. In some examples, the processor of the system 100 may determine whether to continue training of the deep learning algorithm, by assessing overfitting or underfitting. Upon determining that the training of the deep learning algorithm should be stopped, the processor of the system 100 obtains the catalog model in its final form. When the catalog model is finalized, the processor of the system 100 may apply the catalog model to the item for which the request for cataloging is made.

The last column of FIG. 4A shows example application of the catalog model. For example, the processor of the system 100 may collect information about the item whose class is not identified. In such examples, the processor of the system 100 may apply the catalog model, e.g., CIM 804, and obtain at least one characteristic value corresponding to at least one characteristic, and may determine the class of the item based on the at least one characteristic value. Selection of the at least one characteristic may be based on an output of application of the catalog model to the information about the item.

In some implementations, the processor of the system 100, e.g., i-CMP 202, after determining the class of the item, may retain the result of determination within the system 100. (for example, share it with the DLP 230). In such circumstances, the collected information about the item (e.g., at least one characteristic value corresponding to at least one characteristic) in combination with the class of the item, may be shared.

FIG. 4B shows one or more implementations of the autonomous inventory system 100 with the catalog model, taking an example of an adapter of an integrated circuit (IC) in a computer.

As shown in the first column, for collection of data 402a about various objects in different classes, the processor of the system 100, e.g., i-CMG 206, i-CMP 202, may collect information about computers, accessories, and parts that are received at a delivery site from delivery vehicles 120a. The data may be found in the corporate database 214 as well other databases. In other embodiments, information about manufactured computers, parts, accessories may be collected from: notes about repaired computer parts submitted by own service centers; reports about relevant sale statistics of computers submitted by affiliated distribution sites and retail locations, stored in the corporate databases 214; and invoices 113a, 113b, 113c, 113d sent from parts suppliers (ABC Corp., DEF Inc., GHI Indus. Co., JKL Service LLP) including types, model numbers, serial numbers, quantities, and delivery dates. The processor of the system 100 may also retrieve data of circuit designs created by contractors, advertisement materials created by the sales department, storage records 115, acceptance records 116b, 116c, 116d, storage site data in the corporate databases 214, and assembly manuals of computers. Transportation records as well as employee equipment requests may be also collected. Among various data, the processor of the system 100 may find not only makers/suppliers, part/accessory/product type numbers, product model numbers, product/part/accessory serial numbers, unit or discounted bulk prices, quantities, and delivery/report/inspection dates, but also materials (iron, titanium, copper, synthetic polymer), a lifecycle of the object (expiration date, last examination date).

Moving on, the second column of FIG. 4B explains the generation of the catalog model 404b by the processor of the system 100 (e.g., i-CMG 206). Upon collecting relevant data, the processor of the system 100 may generate a set of inputs about the one or more objects (computers, accessories, and parts). In one or more embodiments, the set of inputs about the one or more objects contain a characteristic value of the one or more objects corresponding to a characteristic.

In some embodiments, the processor of the system 100 divides the collected data into a few sets and train the catalog model with one set of the collected data.

In example implementations, the processor of the system 100, e.g., i-CMG 206 may discover class-defining characteristics (e.g., maker, supplier, model number, product number, price, etc.) of each class (e.g., an adapter, a substrate, a transistor, a battery) of the one or more objects and generate the catalog model, e.g., CIM 804, on a deep learning algorithm that predicts a class based on a characteristic value of the one or more objects corresponding to a characteristic. For example, the processor of the system 100 may utilize a transformer to process the set of inputs for training the catalog model. In some embodiments, context vectors (calculation of which may be performed by an encoder RNN) may be utilized as an alternative/additional methodology. More specifically, the processor of the system 100 may parse data for common characteristics of objects in a particular class (an adaptor) or in a particular superclass (a connector to an IC of a computer) to extract characteristic values of characteristics unique to objects in the particular class. The processor of the system 100 examines outputs (prediction results) from the catalog model (e.g., “a circuit?”) and adjusts the hyperparameters and/or architectures of the catalog model, according to one or more embodiments.

The processor of the system 100 may determine whether to continue training of the deep learning algorithm. Upon determining that that the catalog model has been properly trained, the processor of the system 100 obtains the catalog model in its final form.

In the third column of FIG. 4B, examples of the application of the catalog model to the item 406a are demonstrated. In this example, the class of the item may be determined first by collecting information about the item for which the request for cataloging is made. The processor of the system 100 may apply the catalog model and select at least one characteristic value corresponding to at least one characteristic. The processor of the system 100, e.g., i-CMG 206, may find the at least one characteristic value “Derr, Co.” to the at least one characteristic “a supplier.” Also, other characteristic values “X9274,” “$278.98,” and “Centreville VA” of the characteristics “label/model/type.” “price.” and “end user/location/record submission” may be obtained as indicative of the class of the item.

In some implementations, discovering that the collected information about the item matches characteristic values of relevant characteristics for an adapter having a model number “HPE X9274,” the processor of the system 100, e.g., i-CMP 202, may determine the class of the item as an adapter of an IC, based on the at least one characteristic value of the at least one characteristic. The class determination may be distributed within the system 100, for example, shared with the DLP 230. The collected information about the item in relation to the class of the item, may be stored at a memory and submitted to other sub-processors, such as i-CSP 210, i-CEP 212, connected data servers, and devices in data communication with the processor of the system 100.

As such, the processor of the system 100 may, without requiring manual inputs by a cataloging specialist, determine the class of the item, by using the catalog model and the collected information about the item.

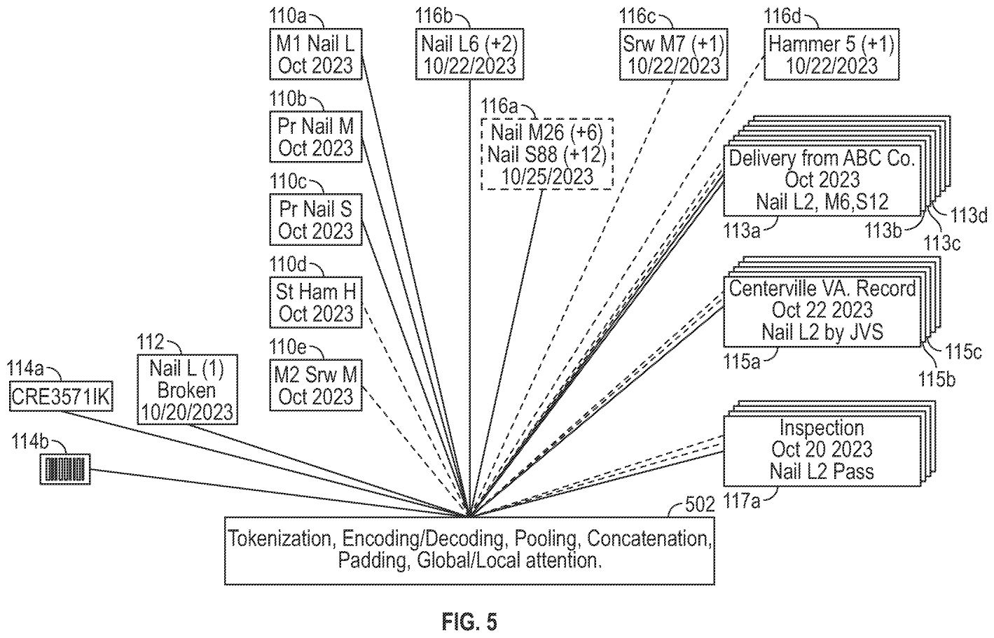

Turning to FIG. 5, a block diagram of the autonomous inventory system 100 according to one or more embodiments is shown. In generating the catalog model in the system 100, the processor of the system 100 may perform any of the following methods to ensure that the catalog model is able to perform automated inventory, including generating a class structure and hierarchy by identifying class-determining characteristics of the one or more objects, identifying a class of objects accurately, and using the collected information about the one or more objects (and the item of the request for cataloging). For example, the information about the one or more objects may be obtained in natural language or random numeric sequences, which may include alphabets, barcodes, tables, image data, and the like. However, certain data analytic methods such as transformers and an RNN may handle only a particular data format. Accordingly, the processor of the system 100 may convert original data to properly processed data, using tokenization, embedding, encoding/decoding, data pooling, concatenation, padding, and/or global/local attention mechanism 502.

In some example implementations, the processor of the system 100 may apply mean pooling to aggregate the contextualized representations into a fixed-length vector. This pooled representation is then supplied to the deep learning algorithm connected with a Soft-max activation function to obtain the prediction.

Embedding is a process in which tokens are mapped to vectors, to be supplied to a deep learning algorithm. During embedding, the processor of the system 100 may encode positions of texts into a vector.

In one example system, the processor of the system 100 may execute instructions to tokenize original data to a string of integer, which may be an index number of a token in a dictionary, or to a vector which allocates a binary coefficient for each token, based on individual data being processed.

In some embodiments, image data may be converted into easily computable data strings. For example, images or audio files are divided to smaller pieces and assembled into a matrix of segments to be encoded.

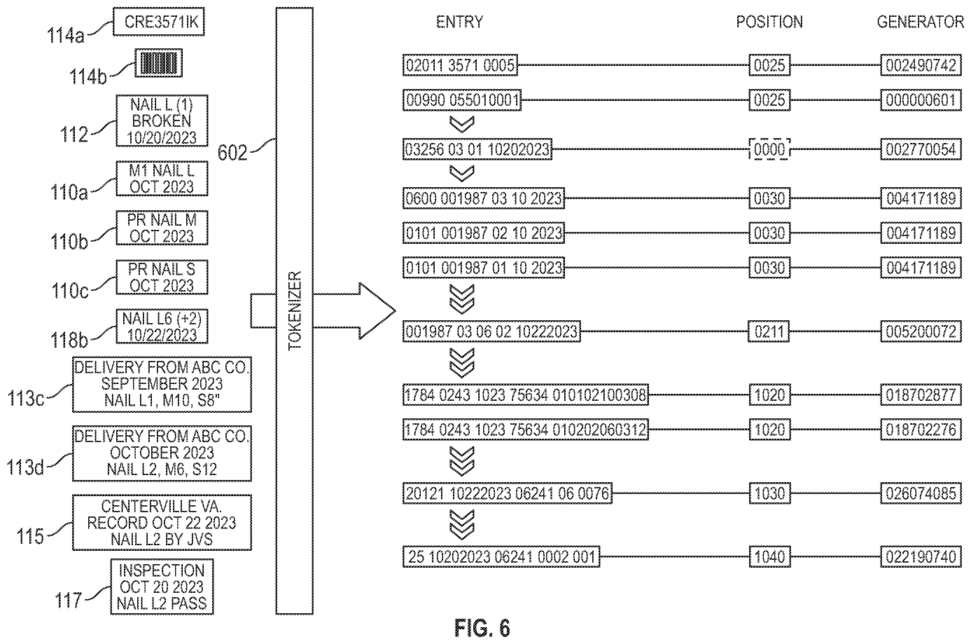

FIG. 6 shows a schematic diagram of the autonomous inventory system 100 in accordance with one or more embodiments. As explained with respect to the tokenization of inputs for the generation of the catalog model in relation to FIG. 3C, the processor of the system 100 may convert natural language into a sequence of integers and separate integers with spaces. In such cases, the processor of the system 100 performs a function as a tokenizer 602. If applicable, class tokens may be also included into tokens. As a result of this process, the processor of the system 100 is able to use tokenized information for analysis by a deep learning algorithm, without losing contextual information.

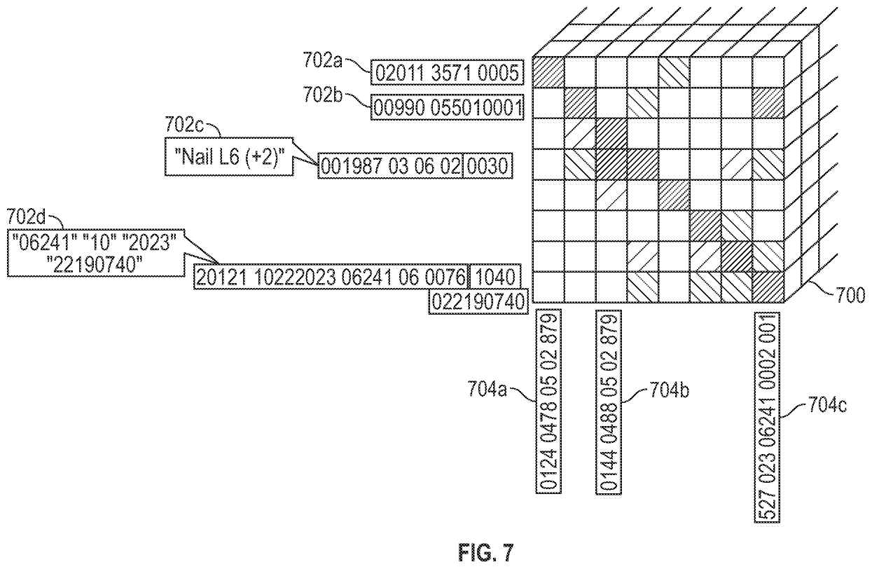

Turning to FIG. 7, the graph 700 in FIG. 7 illustrates one or more exemplary implementations of an attention mechanism in the autonomous inventory system 100 according to one or more embodiments. In the attention mechanism, dynamic weighting of sequential inputs is introduced, and an encoder calculates a degree of relevance of each key to another key to obtain a context vector, as discussed above in relation to FIGS. 3B, 3C. For example, tokenized inputs, including the input “001987 03 06 02” “0030” 702c that represents “Nail L6 (+2),” have different attention scores to a particular output (query). An output for a class of these large nails usually identified with a number 001987 03 is represented by a token “0144 0488 05 02 879” 704b in the shown example. The various degrees of interconnection between the inputs and the query are mapped in the graph 700 in FIG. 7. The dynamic alignment weights (attention) are indicated by the intensity of black (heat map) of cells depending on the importance for predicting each output component. The graph of FIG. 7 shows a strong relationship between the input Nail L6 (+2) in the manufacturing site 142 and the class (large nails usually identified with a number 001987).

FIG. 8 shows a schematic diagram illustrating the autonomous inventory system 100 with a catalog model according to one or more embodiments. For example, the catalog model may include the Class Identification Model (CIM) 804, Duplication Model (DM) 814, and the Duplication Transformer Model (DTM) 812, in accordance with one or more embodiments. Each of these blocks is explained in the following paragraphs.

In one or more exemplary implementations, as depicted in FIG. 8, the processor of the system 100, e.g., i-CMP 202, may have sub-processors that form three main blocks. The first block, CIM 804, uses a deep learning algorithm, such as a multi-class random forest classifier (RFC) to identify the class of the item. CIM 804 may use information about the item, at least one characteristic value corresponding to at least one characteristic, to determine which class the item belongs to.

The class identifiers 822 are selected by CIM 804 and passed to the second block. DM 814 is constructed such that DM 814 is most relevant to the determined class of the item. The third block, DTM 812 contains sub-models pre-trained to conduct search for a duplicate within the relevant class, and decides whether the item has or does not have a duplicate within accessible resources, including the catalog database 216. For example, when CIM 804 identifies the item to be in a valve class, DM 814 selects a specific DM 814 for the valve class.

DTM 812 carries out the following steps, according to one or more embodiments:

(1) Input Representation. The processor of the system 100, e.g., i-CDL 208, may convert information about the item into a suitable format for the DTM 812. This may involve tokenizing texts, breaking data into smaller units (e.g., words or sub words), and adding special tokens to denote the start and end of the sequence.
(2) Transformer. Transformers may consist of an encoder-decoder architecture. In some embodiments, the processor of the system 100 may conduct search within available databases for an entry in the class in which the item is determined to be, focusing on the encoder part. In such embodiments, the encoder is responsible for processing the input sequence and capturing contextualized representations of tokens.
(3) Self-Attention Mechanism. The component of DTMs 812 may include self-attention mechanism. It allows each token in the sequence to attend to all other tokens, capturing the dependencies and relationships between them. The attention mechanism assigns weights to each token based on its relevance to other tokens in the sequence.
(4) Stacked Encoder Layers. DTMs 812 may contain multiple stacked encoder layers. Each encoder layer consists of a self-attention sublayer and a feed-forward neural network sublayer, as explained above. The self-attention sublayer captures the contextualized representations by attending to the entire sequence, while the feed-forward sublayer applies non-linear transformations to enhance the representations further.
(5) Pooling and Classification: After processing the input through the stacked encoder layers, the processor of the system 100 may perform pooling of inputs, aggregating the contextualized representations into a fixed-length vector. The pooled representation may be transmitted to Soft-max activation function to predict whether a duplicate of the item exists in the inventory.
(6) Training and Optimization: The processor of the system 100 may train DTM 812 using a dataset containing information of the one or more objects, where each data point is specified as either existing or non-existing in the inventory. During training, the DTM's parameters are optimized using techniques, such as backpropagation and gradient descent to minimize a suitable loss function, such as binary cross-entropy.
(7) Duplicate Prediction: Once the DTM 812 is trained, the processor of the system 100 may predict whether the item's duplicate exists in the inventory. Information about the one or more objects used in training DTM 812 may also be used in predicting whether a duplicate of the item exists.

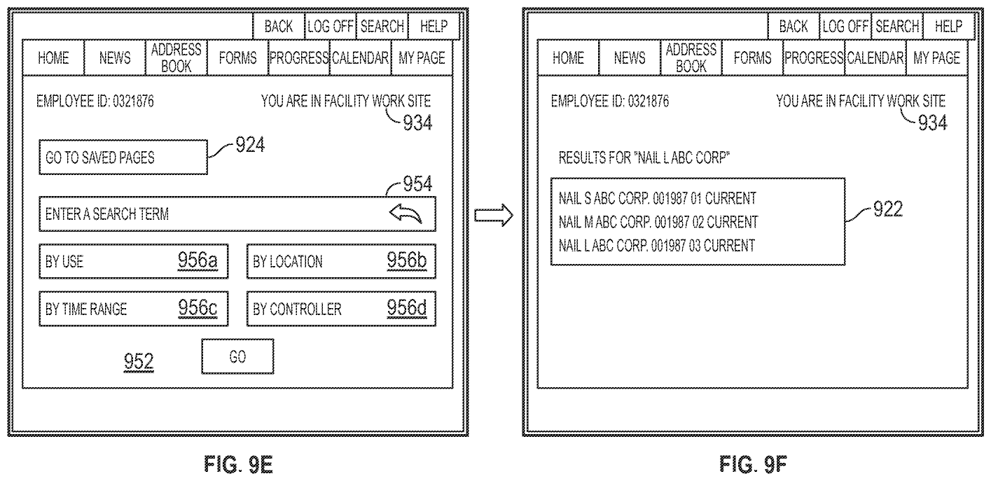

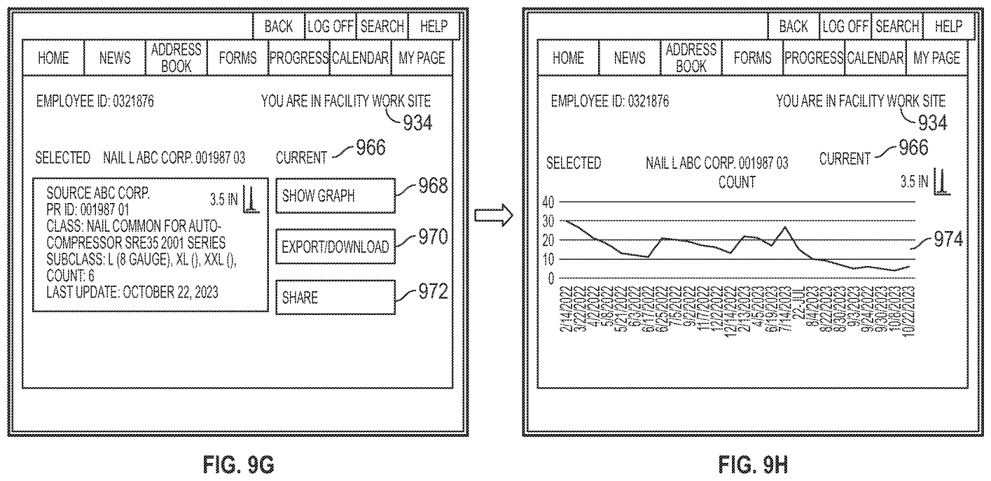

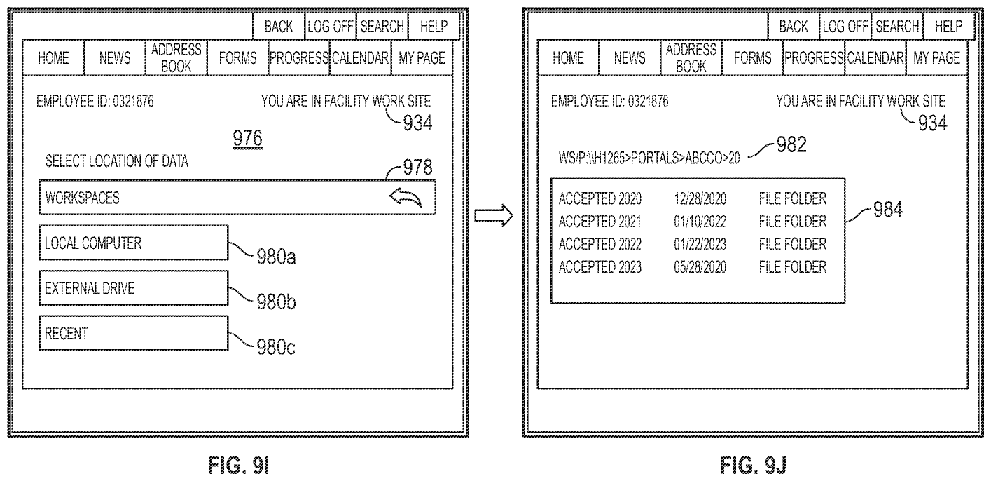

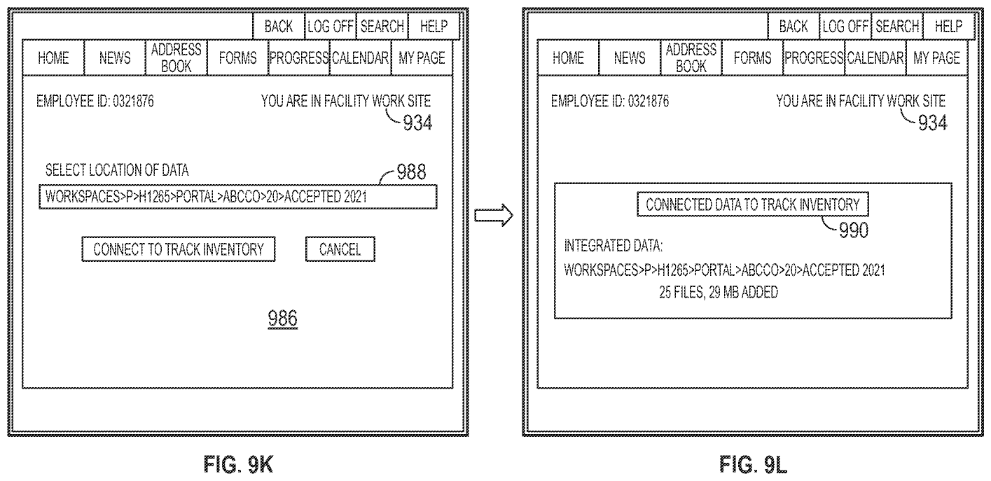

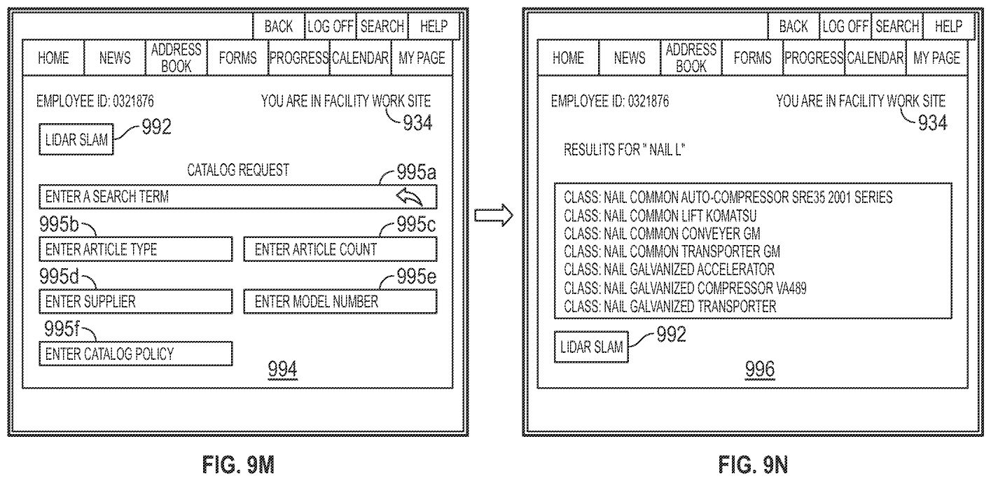

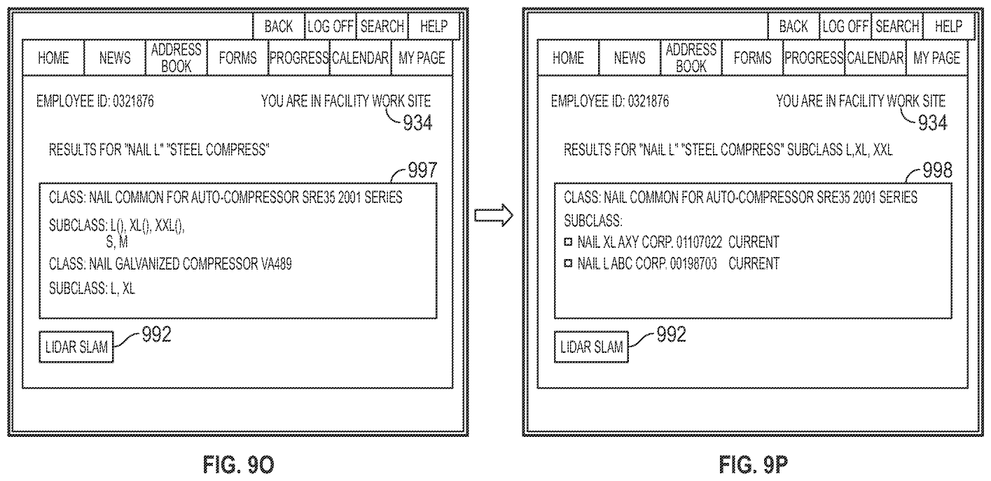

FIGS. 9A to 9P show schematic views of example display screens in the autonomous inventory system 100 in accordance with one or more embodiments. FIGS. 9A to 9P illustrate processes executed to facilitate the management of corporate resources.

FIG. 9A shows the login page of the system 100 in accordance with one or more embodiments. The processor of the system 100 shows fields for an ID 904 and a password 906 to a viewer and prompts the viewer to input an ID and a password so that the viewer's identity and authority to use the system 100 can be determined. If the viewer provides an invalid credential, the processor of the system 100 rejects the login request.

Even if the processor of the system 100 allows the viewer to login, the processor of the system 100 may reject the request for cataloging if the viewer does not the authority to make a request for cataloging. Upon determining that the viewer does not have the authority to make the request for cataloging, e.g., a credential not entered in a list of authorized users, the processor of the system 100 rejects the request and provides a notification (warning) that the request was rejected.

Although not illustrated in FIG. 9A, if the viewer provides a valid credential, the processor of the system 100 may request certain information and documents from the viewer. In some examples, the viewer is required to provide information in the requestor fields, the criteria fields, and the documents fields. If the viewer fails to satisfy the criteria, a notification is given to the viewer. If the criteria are met, the viewer may proceed with the request.

Turning to FIG. 9B, the viewer may be given several choices at the landing page. As shown in FIG. 9B, the processor of the system 100 may permit the viewer to enter Facility Work Site by selecting an icon or a button “Enter Facility Work Site” 914 where the viewer may make a request for cataloging.

FIG. 9C shows the content of Facility Work Site 938. If the viewer enters Facility Work Site 938, the processor of the system 100 provides options for the viewer to make. One of the options may include Tracker site entry by which the viewer may choose to track the inventory. The viewer may select “Tracker” button 936b to check the inventory and/or request cataloging of an item.

FIG. 9D shows the content of Tracker site 940. At Tracker 940 site, the viewer can choose “Track Inventory” icon 946, by which the viewer may track the inventory and import or export data of the inventory.

FIG. 9E shows the content of Track Inventory 952 site. At Track Inventory site 952, the viewer may choose an object the inventory of which can be seen or tracked. The viewer may search the object by entering a search term 954, by selecting one among available options in the dropdown menu, such as the type of use of the object.

FIG. 9F shows the result of a search which the viewer conducted natural language search with term “nail L ABC Corp.” The results 922 show the inventory data including data of Nail S, Nail M, and Nail L, supplied by ABC Corp. The viewer may choose one of these data by clicking on the hyperlink.

FIG. 9G shows the inventory data 966 of an object, Nail L ABC Corp. 001987 03 Current. The inventory data 966 shows the product number, the class, the subclass, the count, etc. of the object.

FIG. 9H shows a graph 974 of the inventory data 966 of the object, Nail L ABC Corp. 001987 03 Current. The viewer can quickly understand the current count of the object, as well as the trend of the inventory of the object. The viewer may download the content or export the data to other locations, for example, by clicking an icon “Export/Download” 970 at the inventory data 966 page.

FIG. 9I shows the content 976 of Data Builder site when the viewer selects “Data Builder” site icon 936a at Facility Work Site 938 as seen in FIG. 9C. At Data Builder site, the viewer may add various data stored in external locations to Track Inventory 952 site of the system 100. For example, data stored in a local computer 980a may be added to the Track Inventory site 952.

FIG. 9J shows the results 984 displayed on the Data Builder site during the selection of a file located in a portal. The viewer may select all the files or some of the files among the results 984 on the Data Builder site.

FIG. 9K shows the content displayed on the Data Builder 986 site during the processing of a file incorporation.

FIG. 9L shows the content displayed on the Data Builder 990 site after the files were added to the Track Inventory site 952.

FIG. 9M shows some of the content 994 displayed on the Catalog site when the viewer selects “Catalog” icon 950 at Tracker 940 site of the system 100, as seen in FIG. 9D. The viewer (or the requester) is prompted to specify the item for which a request for cataloging is made, by entering a type 995b, a count 995c, a cataloging policy 995f, as characteristics of the item. In some embodiments, the processor of the system 100 may require an input of a model number 995e, and a supplier 995d based on the output of the catalog model, e.g., DM 814. If the requester has the item in hand, the requester may choose “Lidar SLAM” icon 992 so that the system 100 is able to identify the item by scanning the item and Lidar SLAM may identify the class of the item by object recognition.

FIG. 9N shows the result 996 of the search when the viewer (or the requester) enters “nail L” as a search term 995a at the Catalog site. The result 996 indicates that there are a number of objects that are related to the search term “nail L.”

FIG. 9O shows the result 997 of the search when the viewer (or the requester) enters “nail L” “steel compress” as a search term 995a. There are two classes of objects that are identifiable with the entered search term “nail L” “steel compress.”

FIG. 9P shows the content 998 displayed on the Catalog site when the viewer (or the requester) chooses the class “Nail common for auto-compressor SRE35 2001 series” among choices in the result 997 displayed on the result. The content shows that the class includes subclasses “Nail XL AXY Corp. 01107022 Current” and “Nail L ABC Corp. 001987 03 Current.”

FIGS. 10A to 10C show flowcharts of a method of automated cataloging in accordance with one or more embodiments. One or more of the individual steps shown in FIGS. 10A to 10C may be omitted, repeated, and/or performed in a different order than the order shown in FIGS. 10A to 10C. Accordingly, the scope of the disclosure should not be limited by the specific arrangement as depicted.

Referring to FIG. 10A, at S1002, the processor of the system 100 receives a request for cataloging an item from a computer device. Upon receiving the request, the processor associated with the process i-CRP 204, requests an input of certain information including an ID and a password of the requester.

At S1010, upon receiving the input of requested information from the requester, the processor of the system 100 determines whether the requester has the authority to make the request for cataloging according to one or more embodiments. For example, the processor may check the requester's identification against a list of authorized users in the catalog database 216 and see whether the requester is authorized.

At S1012, upon determining that the requester does not have the authority to make the request for cataloging, the processor of the system 100 rejects the request and notifies the requester that the request was rejected.

At S1016, in some embodiments, upon determining that the requester has the authority to make the request for cataloging, the processor of the system 100 determines whether the request meets designated criteria. In some examples, the processor of the system 100, e.g., the processor associated with process i-CMP 202, may set the criteria for the request based on the item of the request and require the requester to fill in the requestor fields, the criteria fields, and the documents fields of a request submission form.

At S1018, upon determining that the request does not meet the criteria to make the request for cataloging the item, the processor of the system 100 may notify the requester of the decision that the request is rejected. At S1020, as a correction method, the processor of the system 100 may also search the database to satisfy the criteria.

At S1030, in some embodiments, upon determining that the request meets the criteria to make the request for cataloging the item, the processor of the system 100 generates a catalog model using information about one or more objects. The method of generating the catalog model is explained later in relation to FIG. 10B.

Further, at S1042, the processor of the system 100 applies the catalog model to information about the item, according to one or more embodiments.

At S1050, the processor of the system 100 may search within a database for an entry in the class in which the item is determined to be in. The database may include the corporate database 214 and the catalog database 216.

In some embodiments, at S1056, the processor of the system 100 determines whether there is an entry in the class in which the item is determined to be in.

At S1060, upon finding an entry in the class in which the item is determined to be, the processor of the system 100 updates the database by counting the item into the class, according to one or more embodiments.

At S1080, upon determining that no entry belonging to the class in which the item is determined to be in exits, the processor of the system 100 retrieves the class of the item.

Additionally, at S1082, the processor of the system 100 restructures the database for an entry of the item, by reflecting the characteristic value of the item and the characteristic.

Moving to FIG. 10B, FIG. 10B shows a sequence of detailed processes of S1030's generating the catalog model using information about one or more objects. In some embodiments, at S1032, the processor of the system 100 may collect information about the one or more objects and generate a set of inputs about the one or more objects. The set of inputs about the one or more objects includes a characteristic value of the one or more objects corresponding to a characteristic.

At S1034, the processor of the system 100 may construct a deep learning algorithm. For example, CIM 804 and DM 814 may be constructed with a RFC and a neural network with a transformer, respectively.

Further, at S1036, the processor of the system 100 may train the deep learning algorithm by using at least a part of the set of inputs.

At S1038, the processor of the system 100 may determine whether to continue training of the deep learning algorithm.

In addition, as shown in FIG. 10B, at S1052, the processor of the system 100 may collect information about the item and obtain at least one characteristic value corresponding to at least one characteristic. The at least one characteristic value and the at least one characteristic are chosen by the processor of the system 100 based on the output from the catalog model such that the catalog model, e.g., DM 814, is optimized to identify a duplicate of the item.

In accordance with one or more embodiments, at S1054, the processor of the system 100 may determine the class of the item based on the at least one characteristic value. In this step, the processor of the system 100 applies the catalog model to determine the class of the item.

Referring to FIG. 10C, at S1070, the processor of the system 100 may encode the set of inputs about the one or more objects by calculating a vector. This step may be performed during the generation and application of the catalog model (at S1030 and S1040).

Embodiments disclosed herein advantageously provide an intelligent cataloging method that minimizes cataloging errors through the automation of the conventional cataloging method. This allows for consistency, visibility and traceability in the catalog process. Further, the intelligent cataloging method disclosed herein improves cycles times compared to the conventional cataloging method.

FIG. 11 depicts a block diagram of a computer system used to provide computational functionalities associated with described algorithms, methods, functions, processes, flows, and procedures as described in this disclosure, according to one or more embodiments. The illustrated computer (1102) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include a computer that includes an input device, such as a keypad, keyboard, touch screen, or other device that can accept user information, and an output device that conveys information associated with the operation of the computer (1102), including digital data, visual, or audio information (or a combination of information), or a GUI.

The computer (1102) can serve in a role as a client, network component, a server, a database or other persistency, or any other component (or a combination of roles) of a computer system for performing the subject matter described in the instant disclosure. The illustrated computer (1102) is communicably coupled with a network (1130). In some implementations, one or more components of the computer (1102) may be configured to operate within environments, including cloud-computing-based, local, global, or other environment (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) from a client application (for example, executing on another computer (1102) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or another suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104) includes logic encoded in software or hardware (or a combination of software and hardware) and operable to communicate with the network (1130). More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure.

The computer (1102) also includes a memory (1106) that holds data for the computer (1102) or other components (or a combination of both) that can be connected to the network (1130). For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

There may be any number of computers (1102) associated with, or external to, a computer system containing computer (1102), wherein each computer (1102) communicates over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method of automated cataloging, comprising:
receiving a request for cataloging an item in an inventory from a computer device;
generating a catalog model, using information about one or more objects;
applying the catalog model, using information about the item; and
searching within a database for an entry belonging to a class in which the item is determined to be,
wherein the database stores information about inventories, and
wherein at least a part of the one or more objects is included in the inventories.

2. The method of claim 1, wherein the generating the catalog model using information about one or more objects comprises:
generating a set of inputs about the one or more objects,
wherein the set of inputs comprises a characteristic value of the one or more objects corresponding to a characteristic;
constructing a deep learning algorithm; and
training the deep learning algorithm by using at least a part of the set of inputs.

3. The method of claim 2, wherein the generating the set of inputs about the one or more objects comprises:
encoding the set of inputs about the one or more objects by calculating a vector.

4. The method of claim 2, wherein the applying the catalog model comprises:
collecting information about the item and obtaining at least one characteristic value corresponding to at least one characteristic; and
determining the class of the item based on the at least one characteristic value,
wherein a selection of the at least one characteristic is based on an output of application of the catalog model to the information about the item.

5. The method of claim 2, further comprising:
upon finding no entry belonging to the class in which the item is determined to be in the database,
retrieving the class of the item; and
restructuring the database for an entry of the item, by reflecting the characteristic value of the item and the characteristic.

6. The method of claim 2, further comprising:
upon finding an entry in the class in which the item is determined to be,
updating the database by counting the item into the class.

7. The method of claim 4, wherein the determining the class of the item based on the at least one characteristic value comprises:
comparing the at least one characteristic value with a characteristic value of an object that belongs to the class, corresponding to the at least one characteristic.

8. The method of claim 1, further comprising:
rejecting the request for cataloging upon determining that the requester does not have authority to make the request for cataloging.

9. The method of claim 1, further comprising:
creating a subclass under the class, upon discovering that a first group of objects within the class share a common characteristic value corresponding to a common characteristic that is not shared with a second group of objects within the class.

10. The method of claim 2, further comprising:
transforming the set of inputs about the one or more objects into a vector, by calculating a dynamic weight of an individual key from the set of inputs, wherein the dynamic weight represents a relative importance of each of the individual key to a sequenced element in an output.

11. A system of autonomous inventory, comprising:
a hardware processor in data communication with a computer device and a database that:
receives a request for cataloging an item as an inventory from the computer device;
generates a catalog model, using information about one or more objects;
applies the catalog model, using information about the item; and
searches within a database for an entry belonging to a class in which the item is determined to be in; and
the database configured to store information about inventories,
wherein at least a part of the one or more objects is included in the inventories.

12. The system of claim 11, wherein the hardware processor generates the catalog model using information about one or more objects, by the following steps:
generating a set of inputs about the one or more objects,
wherein the set of inputs about the one or more objects comprises a characteristic value of the one or more objects corresponding to a characteristic;
constructing a deep learning algorithm;
training the deep learning algorithm by using at least a part of the set of inputs; and
determining whether to continue training of the deep learning algorithm.

13. The system of claim 12, wherein the hardware processor generates the set of inputs about the one or more objects, by the following steps:
encoding the set of inputs about the one or more objects by calculating a vector.

14. The system of claim 12, wherein the hardware processor applies the catalog model, by the following steps:
collecting information about the item and obtaining at least one characteristic value corresponding to at least one characteristic; and
determining the class of the item based on the at least one characteristic value,
wherein a selection of the at least one characteristic is based on an output of application of the catalog model to the information about the item.

15. The system of claim 12, wherein the hardware processor, upon finding no entry belonging to the class in which the item is determined to be in the database:
retrieves the class of the item; and
restructures the database for an entry of the item, by reflecting the characteristic value of the item and the characteristic.

16. The system of claim 12, wherein the hardware processor, upon finding an entry in the class in which the item is determined to be,
updates the database by counting the item into the class.

17. The system of claim 14, wherein the hardware processor determines the class of the item based on the at least one characteristic value by the following steps:
comparing the at least one characteristic value with a characteristic value of an object that belongs to the class, corresponding to the at least one characteristic.

18. The system of claim 11, wherein the hardware processor:
rejects the request for cataloging upon determining that the requester does not have authority to make the request for cataloging.

19. The system of claim 11, wherein the hardware processor:
creates a subclass under the class, upon discovering that a first group of objects within the class share a common characteristic value corresponding to a common characteristic that is not shared with a second group of objects within the class.

20. The system of claim 12, wherein the hardware processor:
transforms the set of inputs about the one or more objects into a vector, by calculating a dynamic weight of an individual key from the set of inputs, wherein the dynamic weight represents a relative importance of each of the individual key to a sequenced element in an output.
